(19) United States
(12) Patent Application Publication
(10) Pub. No.: US 2023/0180153 A1
(43) Pub. Date: Jun. 8, 2023

(54) ADAPTIVE DOPPLER FEEDBACK

(71) Applicant: QUALCOMM Incorporated, San Diego, CA (US)

(72) Inventors: Kiran Venugopal, Raritan, NJ (US); Wooseok Nam, San Diego, CA (US); Changhwan Park, San Diego, CA (US); Tao Luo, San Diego, CA (US); Junyi Li, Fairless Hills, PA (US)

(21) Appl. No.: 17/542,248

(22) Filed: Dec. 3, 2021

(51) Int. Cl. H04W 56/00

(52) U.S. Cl. CPC H04W 56/0005; H04W 56/0035

(57) ABSTRACT

Methods, systems, and devices for wireless communications are described. For instance, a user equipment (UE) may receive and measure a reference signal received from a node and may transmit, to the node, a channel feedback report using a resource, the channel feedback report including a first Doppler shift associated with measuring the reference signal. In some examples, the uplink resource may be one of a set of uplink resources indicated to the UE, and the uplink resource may be based on a mobility parameter associated with the UE. Additionally or alternatively, the UE may measure a second reference signal received from the node and may transmit, to the node, a second channel feedback report using a second resource, where the second resource is based on measuring the first reference signal and where the second channel feedback report includes a second Doppler shift associated with measuring the second reference signal.

The following relates to wireless communications, including feedback for wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication at a user equipment (UE) is described. The method may include receiving an indication of one or more uplink resources for channel feedback reporting by the UE, receiving, from one or more nodes, one or more reference signals, and transmitting, via at least one uplink resource of the one or more uplink resources, a channel feedback report including measurement information, where the at least one uplink resource is based on a mobility parameter associated with the UE.

An apparatus for wireless communication at a UE is described. The apparatus may include a processor and memory coupled with the processor. The processor and the memory may be configured to receive an indication of one or more uplink resources for channel feedback reporting by the UE, receive, from one or more nodes, one or more reference signals, and transmit, via at least one uplink resource of the one or more uplink resources, a channel feedback report including measurement information, where the at least one uplink resource is based on a mobility parameter associated with the UE.

Another apparatus for wireless communication at a UE is described. The apparatus may include means for receiving an indication of one or more uplink resources for channel feedback reporting by the UE, means for receiving, from one or more nodes, one or more reference signals, and means for transmitting, via at least one uplink resource of the one or more uplink resources, a channel feedback report including measurement information, where the at least one uplink resource is based on a mobility parameter associated with the UE.

A non-transitory computer-readable medium storing code for wireless communication at a UE is described. The code may include instructions executable by a processor to receive an indication of one or more uplink resources for channel feedback reporting by the UE, receive, from one or more nodes, one or more reference signals, and transmit, via at least one uplink resource of the one or more uplink resources, a channel feedback report including measurement information, where the at least one uplink resource is based on a mobility parameter associated with the UE.

In some examples of the method, apparatuses, and non-transitory computer-readable medium described herein, the one or more uplink resources includes two or more uplink resources and the method, apparatuses, and non-transitory computer-readable medium may include further operations, features, means, or instructions for transmitting, for each of a subset of the two or more uplink resources, a first channel feedback report including a first indication of a first Doppler shift associated with measurement of a first one or more reference signals by the UE.

Some examples of the method, apparatuses, and non-transitory computer-readable medium described herein may further include operations, features, means, or instructions for selecting the subset of the two or more uplink resources based on a delta associated with one or more Doppler shift values based on measurement of the one or more reference signals by the UE.

In some examples of the method, apparatuses, and non-transitory computer-readable medium described herein, the subset of the two or more uplink resources excludes a first uplink resource of the two or more uplink resources based on the delta being below a threshold delta and the first uplink resource may be different than the at least one uplink resource.

Some examples of the method, apparatuses, and non-transitory computer-readable medium described herein may further include operations, features, means, or instructions for receiving, from at least one of the one or more nodes, an indication to select the subset of the two or more uplink resources, where selecting the subset of the two or more uplink resources may be based on receiving the indication to select the subset of the two or more uplink resources.

Some examples of the method, apparatuses, and non-transitory computer-readable medium described herein may further include operations, features, means, or instructions for receiving, from at least one of the one or more nodes, an indication of one or more conditions for selecting the subset of the two or more uplink resources, where selecting the subset of the two or more uplink resources may be based on receiving the indication of the one or more conditions.

Some examples of the method, apparatuses, and non-transitory computer-readable medium described herein may further include operations, features, means, or instructions for receiving an indication of a resource configuration for the one or more uplink resources via semi-static control signaling.

In some examples of the method, apparatuses, and non-transitory computer-readable medium described herein, the one or more uplink resources includes three or more uplink resources and a first time duration between a first uplink resource of the three or more uplink resources and a second uplink resource of the three or more uplink resources that may be adjacent to the first uplink resource may be different than a second time duration between the second uplink resource and a third uplink resource of the three or more uplink resources that may be adjacent to the second uplink resource.

In some examples of the method, apparatuses, and non-transitory computer-readable medium described herein, the first time duration may be different than the second time duration based on the mobility parameter associated with the UE being different in the first time duration relative to the second time duration.

In some examples of the method, apparatuses, and non-transitory computer-readable medium described herein, the indication of the three or more uplink resources includes an irregular time domain pattern for the three or more uplink resources, the irregular time domain pattern associated with a vector indicative of different timings between consecutive sets of uplink resources of the three or more uplink resources.

In some examples of the method, apparatuses, and non-transitory computer-readable medium described herein, the mobility parameter includes a position of the UE, a displacement of the UE, a speed of the UE, a velocity of the UE, an acceleration of the UE, a Doppler shift associated with measurement of the one or more reference signals, or any combination thereof relative to the one or more nodes.

In some examples of the method, apparatuses, and non-transitory computer-readable medium described herein, the one or more uplink resources includes two or more uplink resources and a first uplink resource of the two or more uplink resources may have a different report cycle than a second uplink resource of the two or more uplink resources, the first uplink resource may have a different transmission configuration indicator state than the second uplink resource, or both, based on the first uplink resource being associated with a first geographic region corresponding to a first Doppler variation and the second uplink resource being associated with a second geographic region corresponding to a second Doppler variation.

In some examples of the method, apparatuses, and non-transitory computer-readable medium described herein, the one or more nodes includes one or more transmission reception points.

A method for wireless communication at a UE is described. The method may include measuring a first reference signal received from a node, transmitting, to the node, a first channel feedback report using a first resource, the first channel feedback report including a first Doppler shift associated with measuring the first reference signal, measuring a second reference signal received from the node, and transmitting, to the node, a second channel feedback report using a second resource, the second resource based on measuring the first reference signal, the second channel feedback report including a second Doppler shift associated with measuring the second reference signal.

An apparatus for wireless communication at a UE is described. The apparatus may include a processor and memory coupled with the processor. The processor and the memory may be configured to measure a first reference signal received from a node, transmit, to the node, a first channel feedback report using a first resource, the first channel feedback report including a first Doppler shift associated with measuring the first reference signal, measure a second reference signal received from the node, and transmit, to the node, a second channel feedback report using a second resource, the second resource based on measuring the first reference signal, the second channel feedback report including a second Doppler shift associated with measuring the second reference signal.

Another apparatus for wireless communication at a UE is described. The apparatus may include means for measuring a first reference signal received from a node, means for transmitting, to the node, a first channel feedback report using a first resource, the first channel feedback report including a first Doppler shift associated with measuring the first reference signal, means for measuring a second reference signal received from the node, and means for transmitting, to the node, a second channel feedback report using a second resource, the second resource based on measuring the first reference signal, the second channel feedback report including a second Doppler shift associated with measuring the second reference signal.

A non-transitory computer-readable medium storing code for wireless communication at a UE is described. The code may include instructions executable by a processor to measure a first reference signal received from a node, transmit, to the node, a first channel feedback report using a first resource, the first channel feedback report including a first Doppler shift associated with measuring the first reference signal, measure a second reference signal received from the node, and transmit, to the node, a second channel feedback report using a second resource, the second resource based on measuring the first reference signal, the second channel feedback report including a second Doppler shift associated with measuring the second reference signal.

Some examples of the method, apparatuses, and non-transitory computer-readable medium described herein may further include operations, features, means, or instructions for transmitting, to the node, an indication of the second resource.

In some examples of the method, apparatuses, and non-transitory computer-readable medium described herein, the indication of the second resource includes the first Doppler shift.

Some examples of the method, apparatuses, and non-transitory computer-readable medium described herein may further include operations, features, means, or instructions for receiving, from the node and before measuring the first reference signal, an indication of a set of resources including the first resource and the second resource, where the second resource may be based on receiving the indication of the set of resources.

In some examples of the method, apparatuses, and non-transitory computer-readable medium described herein, a duration between the first resource and the second resource may be based on the first Doppler shift.

Some examples of the method, apparatuses, and non-transitory computer-readable medium described herein may further include operations, features, means, or instructions for receiving, from the node, an indication of a set of Doppler shift ranges, where the duration between the first resource and the second resource may be based on a Doppler shift range of the set of Doppler shift ranges that includes the first Doppler shift.

Some examples of the method, apparatuses, and non-transitory computer-readable medium described herein may further include operations, features, means, or instructions for receiving, from the node, an indication of the second resource for transmitting the second channel feedback report.

Some examples of the method, apparatuses, and non-transitory computer-readable medium described herein may further include operations, features, means, or instructions for transmitting, to the node, a second indication of the second resource, where receiving the indication of the second resource may be based on transmitting the second indication of the second resource.

Some examples of the method, apparatuses, and non-transitory computer-readable medium described herein may further include operations, features, means, or instructions for receiving, from the node and before measuring the first reference signal, an indication of a first set of resources associated with a first resource pattern, the first set of resources including the first resource and receiving, from the node, an indication of a second set of resources associated with a second resource pattern, the second set of resources including the second resource, where the second resource may be based on receiving the indication of the second set of resources.

In some examples of the method, apparatuses, and non-transitory computer-readable medium described herein, the indication of the second resource may be received via a medium access control (MAC) control element (MAC-CE) or downlink control information (DCI).

Some examples of the method, apparatuses, and non-transitory computer-readable medium described herein may further include operations, features, means, or instructions for receiving an indication of an updated transmission configuration indicator state, a configuration for an uplink transmit power control command, or both, associated with a distance or a periodicity of the second resource relative to the first resource.

In some examples of the method, apparatuses, and non-transitory computer-readable medium described herein, the node includes a transmission reception point.

A method for wireless communication at a node is described. The method may include transmitting, to a UE, an indication of one or more uplink resources for channel feedback reporting by the UE, transmitting, to the UE, one or more reference signals, and receiving, via at least one uplink resource of the one or more uplink resources, a channel feedback report including measurement information, where the at least one uplink resource is based on a mobility parameter associated with the UE.

An apparatus for wireless communication at a node is described. The apparatus may include a processor and memory coupled with the processor. The processor and memory may be configured to transmit, to a UE, an indication of one or more uplink resources for channel feedback reporting by the UE, transmit, to the UE, one or more reference signals, and receive, via at least one uplink resource of the one or more uplink resources, a channel feedback report including measurement information, where the at least one uplink resource is based on a mobility parameter associated with the UE.

Another apparatus for wireless communication at a node is described. The apparatus may include means for transmitting, to a UE, an indication of one or more uplink resources for channel feedback reporting by the UE, means for transmitting, to the UE, one or more reference signals, and means for receiving, via at least one uplink resource of the one or more uplink resources, a channel feedback report including measurement information, where the at least one uplink resource is based on a mobility parameter associated with the UE.

A non-transitory computer-readable medium storing code for wireless communication at a node is described. The code may include instructions executable by a processor to transmit, to a UE, an indication of one or more uplink resources for channel feedback reporting by the UE, transmit, to the UE, one or more reference signals, and receive, via at least one uplink resource of the one or more uplink resources, a channel feedback report including measurement information, where the at least one uplink resource is based on a mobility parameter associated with the UE.

In some examples of the method, apparatuses, and non-transitory computer-readable medium described herein, the one or more uplink resources includes two or more uplink resources and the method, apparatuses, and non-transitory computer-readable medium may include further operations, features, means, or instructions for receiving, for each of a subset of the two or more uplink resources, a first channel feedback report including a first indication of a first Doppler shift associated with measurement of a first one or more reference signals by the UE.

In some examples of the method, apparatuses, and non-transitory computer-readable medium described herein, the one or more uplink resources includes three or more uplink resources and a first time duration between a first uplink resource of the three or more uplink resources and a second uplink resource of the three or more uplink resources that may be adjacent to the first uplink resource may be different than a second time duration between the second uplink resource and a third uplink resource of the three or more uplink resources that may be adjacent to the second uplink resource.

A method for wireless communication at a node is described. The method may include transmitting, to a UE, a first reference signal, receiving, from the UE, a first channel feedback report using a first resource, the first channel feedback report including a first Doppler shift based on the first reference signal, transmitting, to the UE, a second reference signal, and receiving, from the UE, a second channel feedback report using a second resource, the second channel feedback report including a second Doppler shift based on the second reference signal, the second resource based on the first reference signal.

An apparatus for wireless communication at a node is described. The apparatus may include a processor and memory coupled with the processor. The processor and the memory may be configured to transmit, to a UE, a first reference signal, receive, from the UE, a first channel feedback report using a first resource, the first channel feedback report including a first Doppler shift based on the first reference signal, transmit, to the UE, a second reference signal, and receive, from the UE, a second channel feedback report using a second resource, the second channel feedback report including a second Doppler shift based on the second reference signal, the second resource based on the first reference signal.

Another apparatus for wireless communication at a node is described. The apparatus may include means for transmitting, to a UE, a first reference signal, means for receiving, from the UE, a first channel feedback report using a first resource, the first channel feedback report including a first Doppler shift based on the first reference signal, means for transmitting, to the UE, a second reference signal, and means for receiving, from the UE, a second channel feedback report using a second resource, the second channel feedback report including a second Doppler shift based on the second reference signal, the second resource based on the first reference signal.

A non-transitory computer-readable medium storing code for wireless communication at a node is described. The code may include instructions executable by a processor to transmit, to a UE, a first reference signal, receive, from the UE, a first channel feedback report using a first resource, the first channel feedback report including a first Doppler shift based on the first reference signal, transmit, to the UE, a second reference signal, and receive, from the UE, a second channel feedback report using a second resource, the second channel feedback report including a second Doppler shift based on the second reference signal, the second resource based on the first reference signal.

Some examples of the method, apparatuses, and non-transitory computer-readable medium described herein may further include operations, features, means, or instructions for receiving, from the UE, an indication of the second resource, where receiving the second channel feedback report using the second resource may be based on receiving the indication of the second resource.

### BRIEF DESCRIPTION OF THE DRAWINGS

FIG. 1 illustrates an example of a wireless communications system that supports adaptive Doppler feedback in accordance with one or more aspects of the present disclosure.

FIG. 2 illustrates an example of a wireless communications system that supports adaptive Doppler feedback in accordance with one or more aspects of the present disclosure.

FIGS. 3A and 3B illustrate examples of feedback resource determination schemes that support adaptive Doppler feedback in accordance with one or more aspects of the present disclosure.

FIG. 4 illustrates an example of a process flow that supports adaptive Doppler feedback in accordance with one or more aspects of the present disclosure.

FIG. 5 illustrates an example of a process flow that supports adaptive Doppler feedback in accordance with one or more aspects of the present disclosure.

FIGS. 6 and 7 show block diagrams of devices that support adaptive Doppler feedback in accordance with one or more aspects of the present disclosure.

FIG. 8 shows a block diagram of a communications manager that supports adaptive Doppler feedback in accordance with one or more aspects of the present disclosure.

FIG. 9 shows a diagram of a system including a device that supports adaptive Doppler feedback in accordance with one or more aspects of the present disclosure.

FIGS. 10 and 11 show block diagrams of devices that support adaptive Doppler feedback in accordance with one or more aspects of the present disclosure.

FIG. 12 shows a block diagram of a communications manager that supports adaptive Doppler feedback in accordance with one or more aspects of the present disclosure.

FIG. 13 shows a diagram of a system including a device that supports adaptive Doppler feedback in accordance with one or more aspects of the present disclosure.

FIGS. 14 through 20 show flowcharts illustrating methods that support adaptive Doppler feedback in accordance with one or more aspects of the present disclosure.

### DETAILED DESCRIPTION

In some examples, a UE may perform communications with a node (e.g., a transmission reception point (TRP), a base station) while moving relative to the node. For instance, the UE may be located within (e.g., coupled with) a vehicle, such as a high-speed train (HST). In examples in which the UE is moving, transmissions received from the node by the UE and/or from the UE by the node may experience a Doppler shift. For instance, if the UE is moving away from the node (e.g., the displacement of the UE relative to the node is increasing), the UE and/or the node may experience a negative Doppler shift. However, if the UE is moving towards the node (e.g., the displacement of the UE relative to the node is decreasing), the UE and/or the node may experience a positive Doppler shift.

As the UE moves faster relative to the node, the magnitude of the Doppler shift may increase. If the node fails to account for the Doppler shift, the node may have a lower likelihood of successfully receiving and/or decoding a transmission from the UE. Similarly, if the UE fails to account for the Doppler shift, the UE may have a lower likelihood of successfully receive and/or decoding a transmission from the node. Further, as Doppler shift measurements change more frequently, the UE may report channel feedback more frequently, which may increase overhead and consume power. Channel feedback may, for instance, include information indicating one or more metrics or values associated with a channel between the UE and the node. For instance, the channel feedback may include channel state feedback (CSF), which may also be referred to as channel state information (CSI). The CSF and/or CSI may include measurement information (e.g., one or more metrics or values calculated from measuring a reference signal that the UE receives from the node, such as a tracking reference signal (TRS) or a channel state information (CSI) reference signal (CSI-RS)). A TRS may be a reference signal that enables the UE to perform time and/or frequency tracking, such as determining a Doppler shift value. A Doppler shift value may be a measure of a change in frequency of the reference signal received by the UE relative to an initial frequency of the reference signal transmitted by the node, where the change in frequency is due to a movement of the UE relative to the node or a movement of the node relative to the UE. In some examples, the measurement information may include a Doppler shift value associated with the received reference signal.

The present disclosure describes techniques (e.g., methods, operations, features, means, or instructions) that may enable a UE to report the Doppler shift using channel feedback, such as measurement information including a Doppler shift value. For instance, the UE may communicate with a first node from which the UE is moving away and a second node towards which the UE is moving. In such examples, the UE may receive a first reference signal from the first node and a second reference signal from the second node, may determine a first Doppler shift by measuring the first reference signal and a second Doppler shift by measuring the second reference signal, and may convey the first Doppler shift to the first node and the second Doppler shift to the second node via the channel feedback. The first and second nodes may perform pre-compensation on transmissions sent to the UE based on the received Doppler shift values, in which the first and second nodes may adjust a center frequency of transmissions according to the Doppler shift values.

Additionally, the present disclosure describes techniques (e.g., methods, operations, features, means, or instructions) that enable uplink resources (e.g., feedback occasions) to be selected (e.g., by the UE, by the first node, by the second node, or any combination thereof) that reduce a number of occasions on which the UE is reporting channel feedback. For instance, the UE may be configured with a set of uplink feedback resources (e.g., via the first node, the second node, or any combination thereof) and may select which of the uplink feedback resources to use based on a mobility parameter (e.g., measured values of the Doppler shift). Additionally or alternatively, the UE may be configured with a set of uplink feedback resources determined by the first node or the second node based on the mobility parameter (e.g., a location or movement of the UE, such as a position, displacement, speed, velocity, or acceleration of the UE, or any combination thereof). Additionally or alternatively, the UE may indicate to the first node or the second node which next resources the UE is to transmit channel feedback over (e.g., based on a Doppler shift the UE has most recently calculated). Additionally or alternatively, the first node or the second node may indicate to the UE which resource the UE is to use next for transmitting the Doppler shift value. Such techniques may reduce overhead and power consumption at a UE reporting channel feedback in mobility scenarios, such as HST scenarios.

Aspects of the disclosure are initially described in the context of wireless communications systems. Additional aspects of the disclosure are described in the context of feedback resource determination schemes. Aspects of the disclosure are further illustrated by and described with reference to apparatus diagrams, system diagrams, and flowcharts that relate to adaptive Doppler feedback.

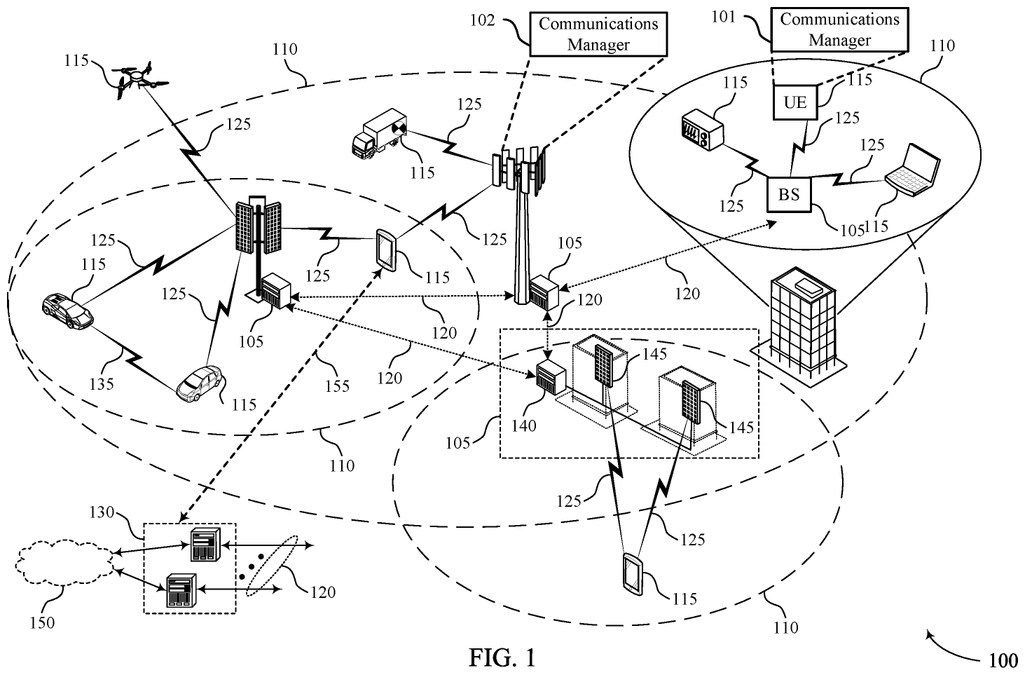

FIG. 1 illustrates an example of a wireless communications system 100 that supports adaptive Doppler feedback in accordance with one or more aspects of the present disclosure. The wireless communications system 100 may include one or more base stations 105, one or more UEs 115, and a core network 130. In some examples, the wireless communications system 100 may be a LTE network, an LTE-A network, an LTE-A Pro network, or a NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or TRPs. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, in some examples in the range of 300 MHz to 300 gigahertz (GHz). In some examples, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, a UE 115 may perform communications with a node (e.g., a TRP, a base station 105) while moving relative to the node. For instance, the UE 115 may be located within (e.g., coupled with) a vehicle, such as a HST. In examples in which the UE is moving, transmissions received by the node from the UE 115 may have an associated Doppler shift. For instance, if the UE is moving away from the node, the node may experience a negative Doppler shift. However, if the UE is moving towards the node, the node may experience a positive Doppler shift. As the UE 115 moves faster relative to the node, the magnitude of the Doppler shift may increase. If the node fails to account for the Doppler shift, the node may have a lower likelihood of successfully receiving and/or decoding a transmission from the UE 115. Further, frequency changes in Doppler shift measurements may result in the UE 115 reporting channel feedback more frequently, which may increase overhead and consume power.

The present disclosure describes techniques (e.g., methods, operations, features, means, or instructions) that may enable a UE 115 to report the Doppler shift using channel feedback (e.g., CSF, such as CSI). For instance, the UE 115 may receive a reference signal from the node, may determine a Doppler shift by measuring the reference signal, and may convey the Doppler shift to the node via the channel feedback. Additionally, the present disclosure may describe techniques (e.g., methods, operations, features, means, or instructions) that enable resources to be selected (e.g., by the UE 115, by the node, or both) that reduce a number of occasions with which the UE 115 is reporting channel feedback. For instance, the UE 115 may be configured with a set of uplink feedback resources (e.g., via the node) and may select which of the uplink feedback resources to use based on measured values of the Doppler shift. Additionally or alternatively, the UE 115 may be configured with a set of uplink feedback resources determined by the node based on a location or movement of the UE 115. Additionally or alternatively, the UE 115 may indicate to the node which next resources the UE 115 is to transmit channel feedback over (e.g., based on a Doppler shift the UE 115 has most recently calculated). Additionally or alternatively, the node may indicate to the UE 115 which resource the UE 115 is to use next for transmitting the Doppler shift value.

In some examples, communications manager 101 may receive an indication of one or more uplink resources for channel feedback reporting by the communications manager 101. Communications manager 101 may receive, from one or more nodes, one or more reference signals. Communications manager 101 may transmit, via at least one uplink resource of the one or more uplink resources, a channel feedback report including measurement information, where the at least one uplink resource is based at least in part on a mobility parameter associated with the communications manager 101. Additionally or alternatively, communications manager 101 may measure a first reference signal received from a node and may transmit, to the node, a first channel feedback report using a first resource, the first channel feedback report including a first Doppler shift associated with measuring the first reference signal. The communications manager 101 may measure a second reference signal from the node and may transmit, to the node, a second channel feedback report using a second resource, the second resource based on measuring the first reference signal, the second channel feedback report including a second Doppler shift associated with measuring the second reference signal.

In some examples, communications manager 102 may transmit an indication of one or more uplink resources for channel feedback reporting by a UE 115. Communications manager 102 may transmit, to the UE 115, one or more reference signals. Communications manager 102 may receive, via at least one uplink resource of the one or more uplink resources and from the UE 115, a channel feedback report including measurement information, where the at least one uplink resource is based at least in part on a mobility parameter associated with the UE 115. Additionally or alternatively, communications manager 102 may transmit a first reference signal to the UE 115 and may receive, from the UE 115, a first channel feedback report using a first resource, the first channel feedback report including a first Doppler shift associated with measuring the first reference signal. The communications manager 102 may transmit a second reference signal to the UE 115 and may receive, from the UE 115, a second channel feedback report using a second resource, the second resource based on measuring the first reference signal, the second channel feedback report including a second Doppler shift associated with measuring the second reference signal.

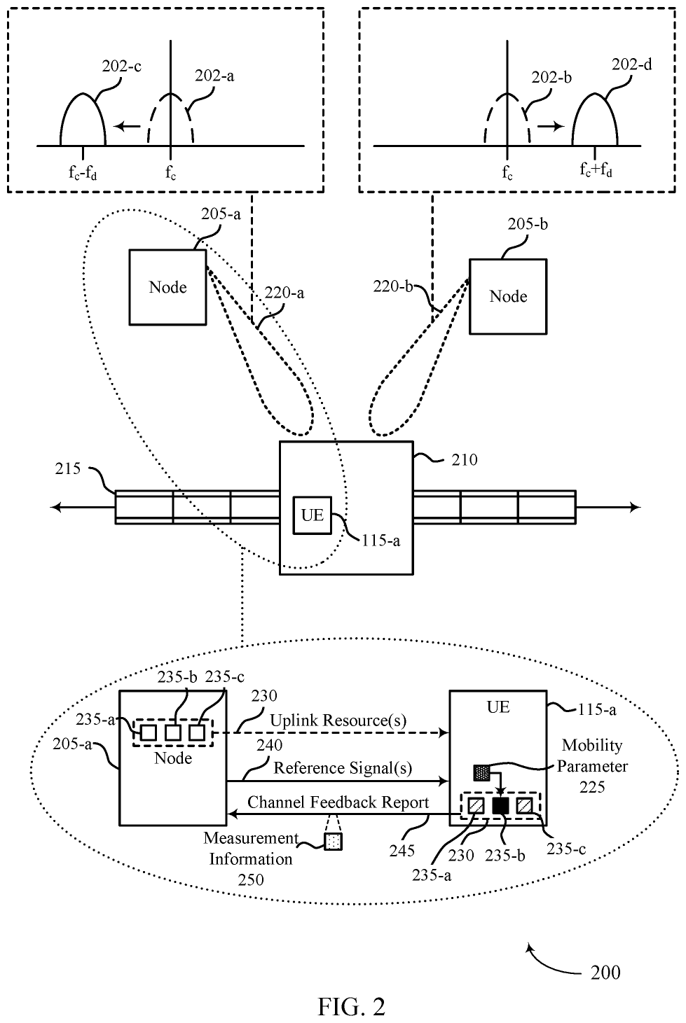

FIG. 2 illustrates an example of a wireless communications system 200 that supports adaptive Doppler feedback in accordance with one or more aspects of the present disclosure. In some examples, wireless communications system 200 may implement one or more aspects of wireless communications system 100. For instance, UE 115-a may be an example of a UE 115 as described with reference to FIG. 1 and nodes 205-a and 205-b may be an example of a TRP or a base station 105 as described with reference to FIG. 1.

UE 115-a may be configured to communicate with nodes 205-a and 205-b. For instance, node 205-a may communicate with UE 115-a via beam 220-a and node 205-b may communicate with UE 115-b via beam 220-b. In some examples, UE 115-a may be located within (e.g., coupled with) a vehicle 210. The vehicle 210 may be an example of for instance, an HST. The vehicle may, additionally or alternatively, be an example of a train, a tram, a car, a truck, a motorcycle, a boat, a plane, or a helicopter. In some examples, the vehicle 210 may move along a path 215. If the vehicle 210 is an HST and/or a train, the path 215 may be an example of a set of tracks (e.g., railroad tracks) along which the vehicle 210 moves.

In some examples, wireless communications system 200 may illustrate an example of single frequency network (SFN) operation for a vehicle 210, such as an HST. Implementing an SFN may involve using multiple nodes to perform communications and the same data may be transmitted over multiple nodes on a same frequency and/or time resource. In examples in which the vehicle 210 is an HST, the speed of the vehicle 210 may be above a threshold amount (e.g., 350 kilometers per mile) and a distance between adjacent nodes (e.g., nodes 205-a and 205-b) may have a particular value (e.g., 200 meters).

While traveling at the speed that is above the threshold amount, the Doppler spread (e.g., a measure of a change of bandwidth in a signal at a receiver as compared to a transmitter) and/or the Doppler shift (e.g., a measure of a change of frequency in a signal at a receiver as compared to a transmitter) at UE 115-a may be above a threshold amount. For instance, communications from or to beam 220-a when UE 115-a is moving away from node 205-a (e.g., when a displacement of UE 115-a relative to node 205-a is increasing) may be associated with a Doppler shift of −f_{D}_{₁} and communications from or to beam 220-b when UE 115-a is moving toward node 205-b (e.g., when a displacement of UE 115-a relative to node 205-b is decreasing) may be associated with a Doppler shift of f_{D}_{₂}. If nodes 205-a and 205-b both transmit respective signaling (e.g., signaling from node 205-a with frequency profile 202-a and signaling from node 205-b with frequency profile 202-b) with a center frequency f_{c}, then UE 115-a may receive the respective signaling from node 205-a with center frequency f_{c}−f_{D}_{₁} (e.g., signaling with frequency profile 202-c) and may receive the respective signaling from node 205-b with center frequency f_{c}+f_{D}_{₂} (e.g., signaling with frequency profile 202-d).

In some examples, nodes 205-a and/or 205-b may perform pre-compensation on a transmission to UE 115-a. Performing pre-compensation may include adjusting a center frequency of a signal to account for Doppler shift. For instance, node 205-a and/or 205-b may transmit a respective TRS to UE 115-a without pre-compensation, where a TRS may be a signal that enables UE 115-a to perform time and/or frequency tracking. UE 115-a may transmit uplink signals with a carrier frequency determined based on the received TRS signals. Nodes 205-a and/or 205-b may transmit a downlink signal (e.g., a downlink control channel transmission, such as a physical downlink control channel (PDCCH) transmission, or a downlink shared channel transmission, such as a physical downlink shared channel (PDSCH) transmission) with a frequency offset pre-compensation determined based on the received signal from UE 115-a. For instance, in the present example, the frequency offset f_{D}_{₁} may be applied to transmissions from node 205-a, where f_{D}_{₁} may be the magnitude of the Doppler shift that transmissions from node 205-a experience when received by UE 115-a, and the frequency offset −f_{D}_{₂} may be applied to transmissions from node 205-b, where f_{D}_{₂} may be the magnitude of the Doppler shift that transmissions from node 205-b experience when received by UE 115-a. In some examples, nodes 205-a and/or 205-b may transmit a second set of TRSs.

In some examples, UE 115-a may indicate Doppler shift values using uplink signals transmitted on the carrier frequency acquired when receiving TRSs from one or both of node 205-a and node 205-b. For instance, UE 115-a may indicate a first Doppler shift value for a first TRS received from node 205-a and a second Doppler shift value for a second TRS received from node 205-b. Additionally or alternatively, UE 115-a may report the Doppler shift values acquired while receiving the TRSs using channel feedback. Conveying the Doppler shift values using channel feedback may be associated with an increase in overhead associated with the channel feedback. For instance, reporting overhead may be determined according to a report size for each reporting instance and an interval between consecutive reporting instances. The report size may be determined according to a quantization size, a carrier frequency, a target Doppler, or any combination thereof. For instance, with 12 bits, a Doppler pre-compensation value with 20 Hz resolution (e.g., the Doppler pre-compensation value may be quantized with respect to a 20 Hz step size) may be reported for a 28 GHz carrier and a 500 kilometers per hour vehicle speed. The reporting interval may be determined according to how quickly Doppler shift values change. For instance, as the Doppler pre-compensation changes more frequently, the reporting interval may decrease. Additionally, as the reporting interval decreases, the power consumption of UE 115-a may increase. Increased power consumption may be associated with a decreased battery life for UE 115-a and may, accordingly, decrease a performance of UE 115-a.

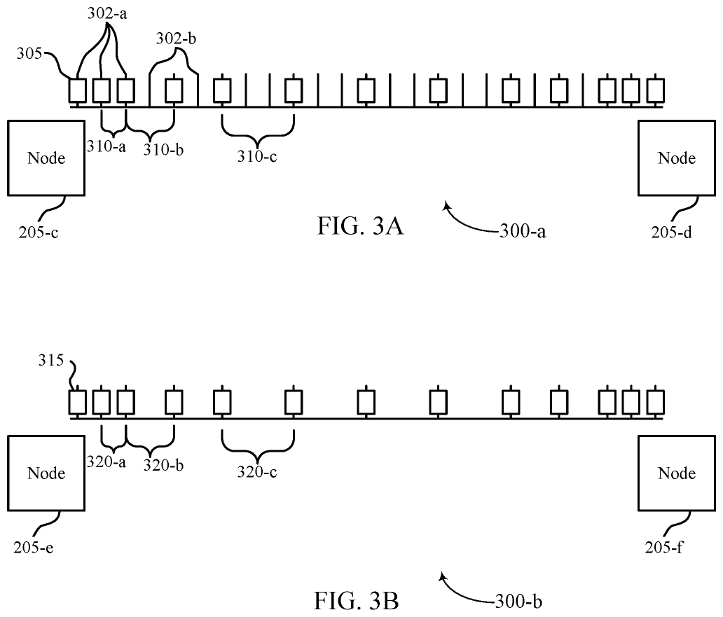

The present disclosure may describe techniques (e.g., methods, operations, features, means, or instructions) that enable resources to be selected (e.g., by the UE 115-a, by nodes 205-a, by node 205-b, or any combination thereof) that reduce a number of occasions with which the UE 115-a is reporting channel feedback. For instance, node 205-a may transmit a set 230 of uplink resources (e.g., including uplink resources 235-a, 235-b, and 235-c) to UE 115-a. Additionally, node 205-a may transmit one or more reference signals 240 to UE 115-a. In some examples, node 205-a may transmit the one or more reference signals via one or more beams (e.g., beam 220-a). After receiving the one or more reference signals 240, UE 115-a may determine measurement information 250 (e.g., a Doppler shift value) associated with the one or more reference signals 240. In some examples, UE 115-a may transmit a channel feedback report 245 over each uplink resource of the set 230 of uplink resources (e.g., each of uplink resources 235-a, 235-b, and 235-c). In some such examples, node 205-a may determine the set 230 of uplink resources based on a mobility parameter 225 (e.g., a displacement, distance, velocity, speed, or acceleration of UE 115-a and/or a Doppler shift value measured by UE 115-a). Additionally or alternatively, UE 115-a may use at least one uplink resource of the set 230 of uplink resources. For instance, based on mobility parameter 225 (e.g., a Doppler shift value measured by UE 115-a), UE 115-a may select uplink resource 235-b for transmitting a channel feedback report 245, but may refrain from transmitting channel feedback reports 245 over uplink resources 235-a and 235-c. Additional details may be described herein, for instance, with reference to FIGS. 3A and 3B.

Additionally or alternatively, UE 115-a may indicate to the node which next resources UE 115-a is to transmit channel feedback over (e.g., based on a Doppler shift UE 115-a has most recently calculated). In some such examples, UE 115-a may perform autonomous adaptation of feedback periodicity. For instance, the duration between two adjacent feedback occasions may be determined by feedback from UE 115-a. In one example, UE 115-a may explicitly indicate a next feedback occasion along with Doppler feedback. For instance, if UE 115-a has been configured with a set of pre-configured uplink resources (e.g., as described herein, for instance, with reference to FIG. 3A), UE 115-a may indicate a next feedback occasion from a set of preconfigured feedback occasions. In another example, the distance to a next feedback occasion may be implicitly determined from the Doppler shift value reported y UE 115-a. For instance, if the reported Doppler shift (e.g., delta Doppler) is above a first threshold, the distance to a next feedback occasion may be below a second threshold (e.g., more frequent reporting). However, if the reported Doppler shift is below the first threshold, the distance to the next feedback occasion may be above the second threshold (e.g., less frequent reporting). To enable this reporting scheme, the Doppler shift values may be divided into multiple ranges, where each range may correspond to a distance to a next feedback occasion. In some examples, the boundaries of the ranges may be configured at UE 115-a (e.g., by node 205-a and/or node 205-b). By indicating a next resource to node 205-a and/or node 205-b, node 205-a and/or node 205-b may perform techniques that may increase uplink resource efficiency and/or network power saving.

Additionally or alternatively, node 205-a and/or node 205-b may indicate to UE 115-a which resource UE 115-a is to use next for transmitting the Doppler shift value. In some such examples, node 205-a and/or node 205-b may provide an indication of feedback periodicity adaptation. For instance, node 205-a and/or node 205-b may indicate to UE 115-a which feedback occasion to use for a next (e.g., one or more) occasion for conveying feedback (e.g., Doppler shift values). For instance, node 205-a and/or node 205-b may provide an indication of a time offset to a next feedback occasion (e.g., instance) and/or by indication of a periodicity. The indication may be in response to feedback from UE 115-a. For instance, UE 115-a may indicate a feedback occasion and node 205-a and/or node 205-b may provide the indication confirming the feedback occasion provided by UE 115-a or selecting a different feedback occasion (e.g., a different uplink occasion). Additionally or alternatively, the indication from node 205-a and/or node 205-b may indicate a modification of a resource pattern for the feedback occasions (e.g., as described herein, for instance, with reference to FIG. 3B). In some examples, the indication of the feedback occasion may be explicitly indicated (e.g., via dedicated MAC control element (MAC-CE) signaling or via downlink control information (DCI) indicating the next feedback occasion). Alternatively, the indication of the feedback occasion may be implicitly indicated and/or implicitly associated with a distance and/or periodicity of the feedback occasion. For instance, the indication of the feedback occasion may be provided via an aperiodic TRS, an aperiodic CSI-RS transmission, a DCI indication for modifying a unified transmission configuration indicator (TCI), a DCI indication for modifying an uplink transmit power control command (e.g., for a physical uplink control channel (PUCCH) transmission, a physical uplink shared channel (PUSCH) transmission or a sounding reference signal (SRS)).

In some examples, uplink feedback resources are associated with a serving synchronization signal block (SSB) and/or an active TCI. In some such examples, node 205-a and/or node 205-b may configure different uplink resources (e.g., different feedback occasions) with different report cycles. The different resources may be associated with different TCI states. The different TCI states may be associated with geographically different regions having different Doppler variations, such as maximum Doppler variation or Doppler ranges. In some examples, semi-static and/or DCI-based switching of SFN, multi-TRP (mTRP), or single TRP (sTRP) schemes may be used to indicate the corresponding feedback occasion.

Performing the techniques (e.g., methods, operations, features, means, or instructions) described herein may enable UE 115-a to reduce the number of feedback occasions over which UE 115-a transmits channel feedback. Accordingly, the power consumption of UE 115-a may decrease. Decreasing the power consumption of UE 115-a may enable UE 115-a to stay powered on for a longer duration and increase battery life. Examples in which UE 115-a may select resources from a preconfigured set based on a metric may be associated with a reduced number of resources used for transmitting channel feedback as compared to examples in which UE 115-a uses each resource of the preconfigured set. However, examples in which UE 115-a uses each resource of the preconfigured may be associated with fewer processing operations and/or overhead as compared to examples in which UE 115-a selects resources from a preconfigured set based on the metric. Additionally, examples in which UE 115-a does not receive or transmit a resource for each time UE 115-a transmits channel feedback may be associated with less overhead than UE 115-a transmitting and/or receiving an indication of a resource each time UE 115-a transmits channel feedback. However, examples in which UE 115-a transmits and/or receives an indication of a resource each time UE 115-a transmits channel feedback may enable a node (e.g., node 205-a, 205-b) to dynamically adjust a behavior of the node (e.g., dynamically change the resources configured at UE 115-a for channel feedback, dynamically schedule new resources at UE 115-a for channel feedback). Accordingly, the efficiency of wireless communications may increase.

FIGS. 3A and 3B illustrate examples of feedback resource determination schemes 300-a and 300-b that support adaptive Doppler feedback in accordance with one or more aspects of the present disclosure. In some examples, feedback resource determination schemes 300-a and 300-b may be implemented by one or more aspects of wireless communications systems 100 and/or 200. For instance, feedback resource determination schemes 300-a and 300-b may depict examples of uplink resources (e.g., feedback occasions) determined or identified by a UE 115 or UE 115-a for conveying channel feedback. Additionally, nodes 205-c, 205-d, 205-e, and 205-f may each be an example of a TRP, a base station 105 as described with reference to FIG. 1, a node 205-a as described with reference to FIG. 2, or a node 205-b as described with reference to FIG. 2.

FIG. 3A may illustrate an example of a feedback resource determination scheme 300-a. Feedback resource determination scheme 300-a may include a set of uplink resources configured by a node (e.g., one of nodes 205-c and 205-d) for conveying channel feedback 305. In feedback resource determination scheme 300-a, a UE 115 may convey autonomous feedback over a pre-configured set of uplink resources (e.g., uplink feedback resources configured via PUCCH transmissions, configured grant (CG) transmissions). For instance, the UE 115 may use a subset of pre-configured resources for transmitting channel feedback 305 (e.g., uplink resources 302-a) and may skip the remaining pre-configured resources (e.g., uplink resources 302-b). Additionally, the UE 115 may select which uplink resources are in the subset based on a measured Doppler delta. For instance, the Doppler delta associated with immediately adjacent uplink resources 302-a may be associated with a shorter interval 310-a than an interval 310-b between uplink resources with an unused uplink resources 302-b between them because the Doppler delta for the immediately adjacent uplink resources 302-a may be higher than the Doppler delta for the uplink resources 302-a with an unused uplink resources 302-b between them. Similarly, the Doppler delta associated with uplink resources 302-a with a single unused uplink resource 302-b between them may be associated with a shorter interval 310-b than an interval 310-c between the uplink resources 302-a with multiple immediately adjacent unused uplink resources 302-b between them because the Doppler delta for the uplink resources 302-a with a single unused uplink resources 302-b between them may be higher than the Doppler delta for the uplink resources 302-a with multiple immediately adjacent unused uplink resources 302-b between them. For instance, when UE 115-f is farther from node 205-c and 205-d (e.g., in between node 205-c and node 205-d), the Doppler delta may be smaller than when UE 115-f is closer to node 205-c or node 205-d, respectively. In some examples, the node (e.g., one of nodes 205-c or 205-d) may configure uplink resources (e.g., feedback resources semi-statically). Additionally, the node (e.g., one of nodes 205-c or 205-d) may configure conditions to trigger UE autonomous feedback. The condition may trigger reporting or may trigger no reporting. In some examples, each of the set of pre-configured uplink resources may be spaced out evenly from each other.

FIG. 3B may illustrate an example of a uplink resource determination scheme 300-b. Feedback resource determination scheme 300-b may include a set of uplink resources (e.g., uplink resources) configured by a node (e.g., one of nodes 205-e or 205-f) for conveying channel feedback 315. In some examples, the set of uplink resources may have an irregular pattern configured by the node (e.g., one of nodes 205-e or 205-f). The pattern may be irregular (e.g., not periodic) because the feedback resources may not be periodic. Additionally, a time duration between two adjacent uplink resources (e.g., feedback instances, feedback resources) may swing between multiple values (e.g., N₁ slots and N₂ slots). For instance, when vehicle 210 is in the center between nodes 205-e and 205-f, the distance (e.g., duration) between two uplink resources may be larger (e.g., less frequent reporting) than when the vehicle 210 is closer to node 205-e or node 205-f (e.g., more frequent reporting). In the present example, interval 320-a may be shorter than interval 320-b because a vehicle may be closer to the node 205-e or 205-f during interval 320-a than interval 320-b. Similarly, interval 320-b may be shorter than interval 320-c because the vehicle may be closer to the node 205-e or 205-f during interval 320-b than interval 320-c. In some examples, a time domain pattern corresponding to the set of uplink resources may be parameterized with a vector of inter-feedback distances (e.g., durations). In some examples, the node 205-e or 205-f may configure a new set of uplink resources corresponding to an updated time domain pattern if a speed of a vehicle (e.g., vehicle 210) changes.

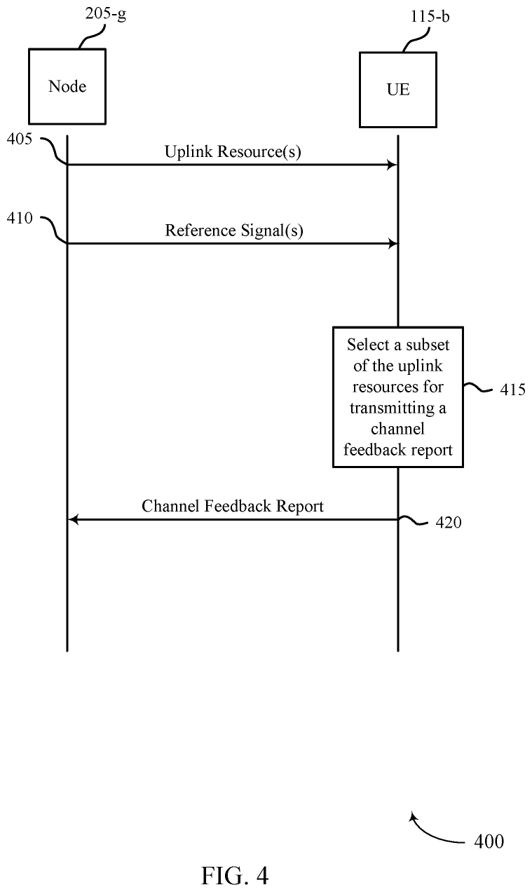

FIG. 4 illustrates an example of a process flow 400 that supports adaptive Doppler feedback in accordance with one or more aspects of the present disclosure. In some examples, process flow 400 may be implemented by one or more aspects of wireless communications systems 100 and/or 200. For instance, UE 115-b may be an example of a UE 115 as described with reference to FIG. 1 or UE 115-a as described with reference to FIG. 2. Additionally, node 205-g may be an example of a base station 105 as described with reference to FIG. 1, a node 205-a as described with reference to FIG. 2, or a node 205-b as described with reference to FIG. 2.

At 405, node 205-g may transmit, to UE 115-b, an indication of one or more uplink resources (e.g., feedback occasions) for channel feedback reporting by UE 115-b. In some examples, UE 115-b may receive an indication of a resource configuration for the one or more uplink resources via semi-static control signaling. Additionally or alternatively, in examples in which the one or more uplink resources include three or more uplink resources, a first time duration between a first uplink resource of the three or more uplink resources and a second uplink resource of the three or more uplink resources adjacent to the first uplink resource may be different than a second time duration between the second uplink resource and a third uplink resource of the three or more uplink resources adjacent to the second uplink resource. In some such examples, the first time duration may be different than the second time duration based on the mobility parameter associated with UE 115-b being different in the first time duration relative to the second time duration. In some examples, the indication of the three or more uplink resources includes an irregular time domain pattern for the three or more uplink resources, the irregular time domain pattern associated with a vector indicative of different timings between consecutive sets of uplink resources of the three or more uplink resources.

In some examples, the mobility parameter may include a position of UE 115-b, a displacement of UE 115-b, a speed of UE 115-b, a velocity of UE 115-b, an acceleration of UE 115-b, a Doppler shift associated with measurement of the one or more reference signals, or any combination thereof relative to the one or more nodes. In examples in which the one or more uplink resources include two or more uplink resources, a first uplink resource of the two or more uplink resources may have a different report cycle than a second uplink resource of the two or more uplink resources, the first uplink resource may have a different TCI state than the second uplink resource, or both based on the first uplink resource being associated with a first geographic region corresponding to a first Doppler variation and the second resource being associated with a second geographic region corresponding to a second Doppler variation.

At 410, node 205-g may transmit, to UE 115-b, one or more reference signals (e.g., one or more CSI-RSs).

At 415, in examples in which the one or more uplink resources include two or more uplink resources, UE 115-c may select the subset of the two or more uplink resources based on a delta associated with one or more Doppler shift values based on measurement of the one or more reference signals by UE 115-b. In some such examples, the subset of the two or more uplink resources may exclude at least one uplink resource of the two or more uplink resources based on the delta being below a threshold delta. Additionally or alternatively, UE 115-b may receive, from node 205-g or another node, an indication to select the subset of the two or more uplink resources, where selecting the subset is based on receiving the indication. In some such examples, UE 115-b may receive, from node 205-g, an indication of one or more conditions for selecting the subset of the two or more uplink resources, where selecting the subset of the two or more uplink resources is based on receiving the indication of the one or more conditions.

At 420, UE 115-b may transmit, via at least one uplink resource of the one or more uplink resources and to node 205-g, a channel feedback report including measurement information, where the at least one uplink resource is based on a mobility parameter associated with UE 115-b. In examples in which the one or more uplink resources include two or more uplink resources, UE 115-b may transmit, for each of a subset of the two or more uplink resources, a first channel feedback report including a first indication of a first Doppler shift associated with measurement of a first one or more reference signals by UE 115-b.

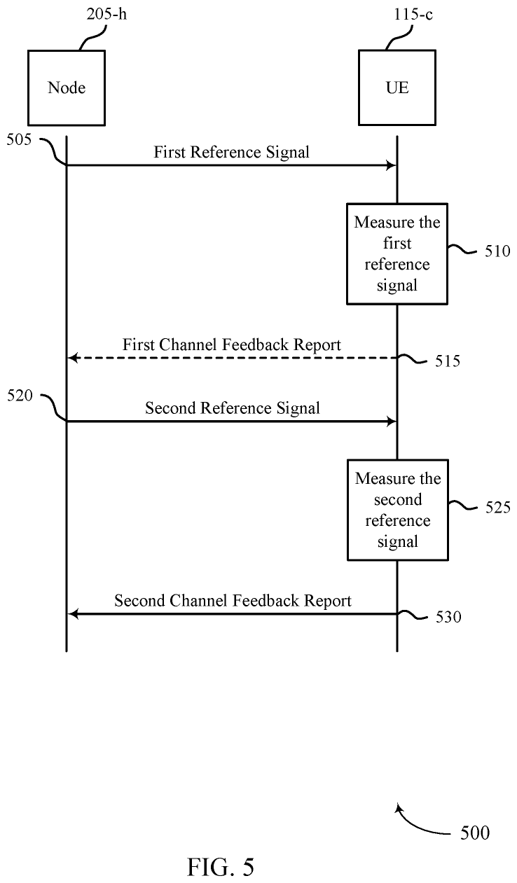

FIG. 5 illustrates an example of a process flow 500 that supports adaptive Doppler feedback in accordance with one or more aspects of the present disclosure. In some examples, process flow 500 may be implemented by one or more aspects of wireless communications systems 100 and/or 200. For instance, UE 115-c may be an example of a UE 115 as described with reference to FIG. 1 or UE 115-a as described with reference to FIG. 2. Additionally, node 205-h may be an example of a base station 105 as described with reference to FIG. 1, a node 205-a as described with reference to FIG. 2, or a node 205-b as described with reference to FIG. 2.

At 505, node 205-h may transmit, to UE 115-c, a first reference signal (e.g., a CSI-RS).

At 510, UE 115-c may measure the first reference signal.

At 515, UE 115-c may transmit, to node 205-h, a first channel feedback report using a first resource, the first channel feedback report including a first Doppler shift associated with measuring the first reference signal.

At 520, node 205-h may transmit, to UE 115-c, a second reference signal (e.g., a CSI-RS).

At 525, UE 115-c may measure the second reference signal.

At 530, UE 115-c may transmit, to node 205-h, a second channel feedback report using a second resource, the second resource based on measuring the first reference signal, the second channel feedback report including a second Doppler shift associated with measuring the second reference signal.

In some examples, UE 115-c may transmit, to node 205-h, an indication of the second resource. In some such examples, the indication of the second resource may include the first Doppler shift. Additionally or alternatively, node 205-h may transmit, to UE 115-c and before measuring the first reference signal, an indication of a set of resources including the first resource and the second resource, where the second resource is based on receiving the indication of the set of resources.

In some examples, a duration between the first resource and the second resource is based on the first Doppler shift. In some such examples, UE 115-c may transmit, to node 205-h, an indication of a set of Doppler shift ranges, where the duration between the first resource and the second resource is based on a Doppler shift range of the set of Doppler shift ranges that includes the first Doppler shift.

In some examples, node 205-h may transmit, to UE 115-c, an indication of the second resource for transmitting the second channel feedback report. In some such examples, UE 115-c may transmit, to node 205-h, a second indication of the second resource, where receiving the indication of the second resource may be based on transmitting the second indication of the second resource. Additionally, node 205-h may transmit, to UE 115-c and before UE 115-c measures the first reference signal, an indication of a first set of resources associated with a first resource pattern, the first set of resources including the first resource and may also transmit, to UE 115-c, an indication of a second set of resources associated with a second resource pattern, the second set of resources including the second resource, where the second resource is based on receiving the indication of the second set of resources. In some examples, the indication of the second resource is received via a MAC-CE or DCI. In some examples, node 205-h may transmit, to UE 115-c, an indication of an updated TCI state, an uplink transmit power control (TPC) command, or both, associated with a distance or a periodicity of the second resource relative to the first resource.

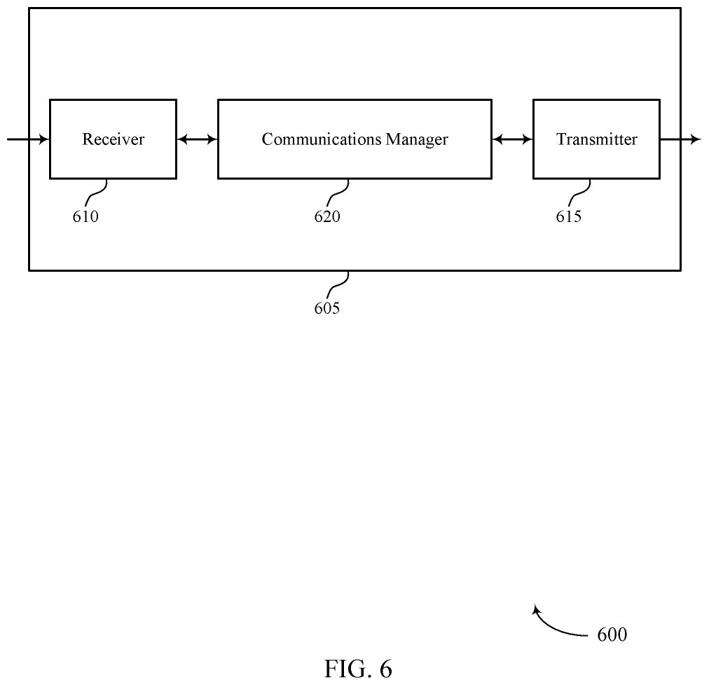

FIG. 6 shows a block diagram 600 of a device 605 that supports adaptive Doppler feedback in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to adaptive Doppler feedback). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to adaptive Doppler feedback). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of adaptive Doppler feedback as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving an indication of one or more uplink resources for channel feedback reporting by the UE. The communications manager 620 may be configured as or otherwise support a means for receiving, from one or more nodes, one or more reference signals. The communications manager 620 may be configured as or otherwise support a means for transmitting, via at least one uplink resource of the one or more uplink resources, a channel feedback report including measurement information, where the at least one uplink resource is based on a mobility parameter associated with the UE.

Additionally or alternatively, the communications manager 620 may support wireless communication at a UE in accordance with examples as disclosed herein. For example, the communications manager 620 may be configured as or otherwise support a means for measuring a first reference signal received from a node. The communications manager 620 may be configured as or otherwise support a means for transmitting, to the node, a first channel feedback report using a first resource, the first channel feedback report including a first Doppler shift associated with measuring the first reference signal. The communications manager 620 may be configured as or otherwise support a means for measuring a second reference signal received from the node. The communications manager 620 may be configured as or otherwise support a means for transmitting, to the node, a second channel feedback report using a second resource, the second resource based on measuring the first reference signal, the second channel feedback report including a second Doppler shift associated with measuring the second reference signal.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for the device 605 to reduce power consumption by reducing a number of uplink resources over which the device 605 conveys channel feedback.

The communications manager 620 may be an example of means for performing various aspects of adaptive Doppler feedback as described herein. The communications manager 620, or its sub-components, may be implemented in hardware (e.g., in communications management circuitry). The circuitry may comprise of processor, digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

In another implementation, the communications manager 620, or its sub-components, may be implemented in code (e.g., as communications management software or firmware) executed by a processor, or any combination thereof. If implemented in code executed by a processor, the functions of the communications manager 620, or its sub-components may be executed by a general-purpose processor, a digital signal processor (DSP), an application-specific integrated circuit (ASIC), a field programmable gate array (FPGA) or other programmable logic device.

In some examples, the communications manager 620 may be configured to perform various operations (e.g., receiving, determining, transmitting) using or otherwise in cooperation with the receiver 610, the transmitter 615, or both.

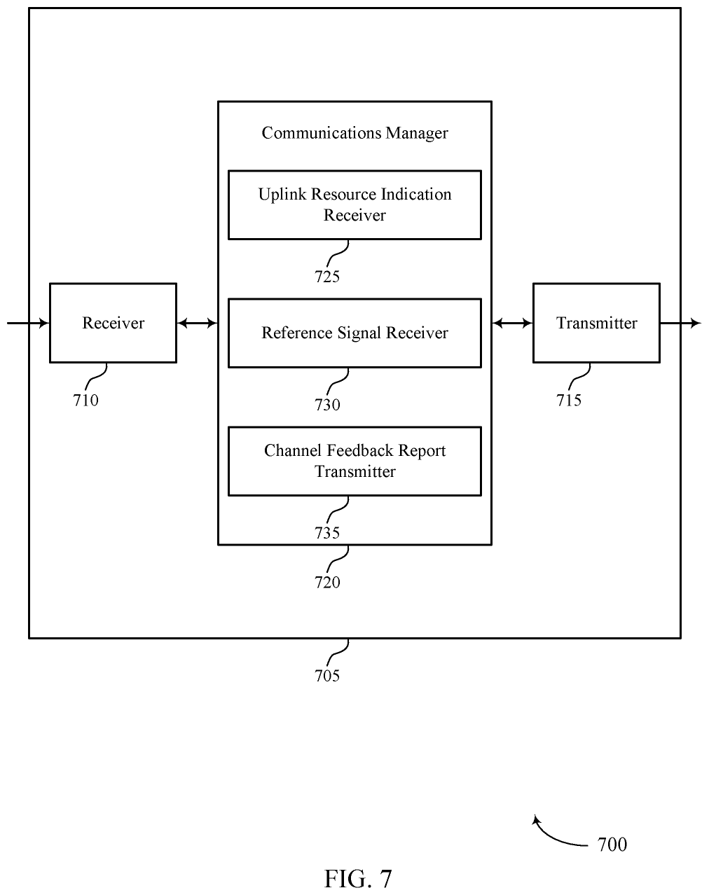

FIG. 7 shows a block diagram 700 of a device 705 that supports adaptive Doppler feedback in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptive Doppler feedback). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptive Doppler feedback). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of adaptive Doppler feedback as described herein. For example, the communications manager 720 may include an uplink resource indication receiver 725, a reference signal receiver 730, a channel feedback report transmitter 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The uplink resource indication receiver 725 may be configured as or otherwise support a means for receiving an indication of one or more uplink resources for channel feedback reporting by the UE. The reference signal receiver 730 may be configured as or otherwise support a means for receiving, from one or more nodes, one or more reference signals. The channel feedback report transmitter 735 may be configured as or otherwise support a means for transmitting, via at least one uplink resource of the one or more uplink resources, a channel feedback report including measurement information, where the at least one uplink resource is based on a mobility parameter associated with the UE.

Additionally or alternatively, the communications manager 720 may support wireless communication at a UE in accordance with examples as disclosed herein. The reference signal receiver 730 may be configured as or otherwise support a means for measuring a first reference signal received from a node. The channel feedback report transmitter 735 may be configured as or otherwise support a means for transmitting, to the node, a first channel feedback report using a first resource, the first channel feedback report including a first Doppler shift associated with measuring the first reference signal. The reference signal receiver 730 may be configured as or otherwise support a means for measuring a second reference signal received from the node. The channel feedback report transmitter 735 may be configured as or otherwise support a means for transmitting, to the node, a second channel feedback report using a second resource, the second resource based on measuring the first reference signal, the second channel feedback report including a second Doppler shift associated with measuring the second reference signal.

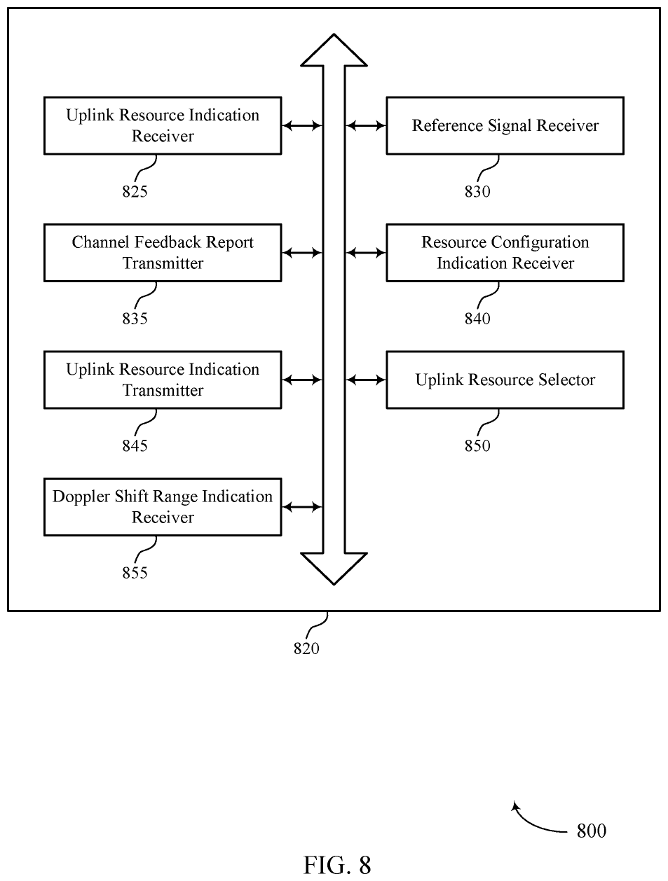

FIG. 8 shows a block diagram 800 of a communications manager 820 that supports adaptive Doppler feedback in accordance with one or more aspects of the present disclosure. The communications manager 820 may be an example of aspects of a communications manager 620, a communications manager 720, or both, as described herein. The communications manager 820, or various components thereof, may be an example of means for performing various aspects of adaptive Doppler feedback as described herein. For example, the communications manager 820 may include an uplink resource indication receiver 825, a reference signal receiver 830, a channel feedback report transmitter 835, a resource configuration indication receiver 840, an uplink resource indication transmitter 845, an uplink resource selector 850, a Doppler shift range indication receiver 855, or any combination thereof. Each of these components may communicate, directly or indirectly, with one another (e.g., via one or more buses).

The communications manager 820 may support wireless communication at a UE in accordance with examples as disclosed herein. The uplink resource indication receiver 825 may be configured as or otherwise support a means for receiving an indication of one or more uplink resources for channel feedback reporting by the UE. The reference signal receiver 830 may be configured as or otherwise support a means for receiving, from one or more nodes, one or more reference signals. The channel feedback report transmitter 835 may be configured as or otherwise support a means for transmitting, via at least one uplink resource of the one or more uplink resources, a channel feedback report including measurement information, where the at least one uplink resource is based on a mobility parameter associated with the UE.

In some examples, the one or more uplink resources includes two or more uplink resources, and the channel feedback report transmitter 835 may be configured as or otherwise support a means for transmitting, for each of a subset of the two or more uplink resources, a first channel feedback report including a first indication of a first Doppler shift associated with measurement of a first one or more reference signals by the UE.

In some examples, the uplink resource selector 850 may be configured as or otherwise support a means for selecting the subset of the two or more uplink resources based on a delta associated with one or more Doppler shift values based on measurement of the one or more reference signals by the UE.

In some examples, the subset of the two or more uplink resources excludes a first uplink resource of the two or more uplink resources based at least in part on the delta being below a threshold delta, where the first uplink resource is different than the at least one uplink resource.

In some examples, the uplink resource selector 850 may be configured as or otherwise support a means for receiving, from at least one of the one or more nodes, an indication to select the subset of the two or more uplink resources, where selecting the subset of the two or more uplink resources is based on receiving the indication to select the subset of the two or more uplink resources.

In some examples, the uplink resource selector 850 may be configured as or otherwise support a means for receiving, from at least one of the one or more nodes, an indication of one or more conditions for selecting the subset of the two or more uplink resources, where selecting the subset of the two or more uplink resources is based on receiving the indication of the one or more conditions.

In some examples, the resource configuration indication receiver 840 may be configured as or otherwise support a means for receiving an indication of a resource configuration for the one or more uplink resources via semi-static control signaling.

In some examples, the one or more uplink resources includes three or more uplink resources. In some examples, a first time duration between a first uplink resource of the three or more uplink resources and a second uplink resource of the three or more uplink resources that is adjacent to the first uplink resource is different than a second time duration between the second uplink resource and a third uplink resource of the three or more uplink resources that is adjacent to the second uplink resource.

In some examples, the first time duration is different than the second time duration based on the mobility parameter associated with the UE being different in the first time duration relative to the second time duration.

In some examples, the mobility parameter includes a position of the UE, a displacement of the UE, a speed of the UE, a velocity of the UE, an acceleration of the UE, a Doppler shift associated with measurement of the one or more reference signals, or any combination thereof relative to the one or more nodes.

In some examples, the indication of the three or more uplink resources includes an irregular time domain pattern for the three or more uplink resources, the irregular time domain pattern associated with a vector indicative of different timings between consecutive sets of uplink resources of the three or more uplink resources.

In some examples, the one or more uplink resources includes two or more uplink resources. In some examples, a first uplink resource of the two or more uplink resources has a different report cycle than a second uplink resource of the two or more uplink resources, the first uplink resource has a different transmission configuration indicator state than the second uplink resource, or both, based on the first uplink resource being associated with a first geographic region corresponding to a first Doppler variation and the second uplink resource being associated with a second geographic region corresponding to a second Doppler variation.

In some examples, the one or more nodes includes one or more transmission reception points.

Additionally or alternatively, the communications manager 820 may support wireless communication at a UE in accordance with examples as disclosed herein. In some examples, the reference signal receiver 830 may be configured as or otherwise support a means for measuring a first reference signal received from a node. In some examples, the channel feedback report transmitter 835 may be configured as or otherwise support a means for transmitting, to the node, a first channel feedback report using a first resource, the first channel feedback report including a first Doppler shift associated with measuring the first reference signal. In some examples, the reference signal receiver 830 may be configured as or otherwise support a means for measuring a second reference signal received from the node. In some examples, the channel feedback report transmitter 835 may be configured as or otherwise support a means for transmitting, to the node, a second channel feedback report using a second resource, the second resource based on measuring the first reference signal, the second channel feedback report including a second Doppler shift associated with measuring the second reference signal.

In some examples, the uplink resource indication transmitter 845 may be configured as or otherwise support a means for transmitting, to the node, an indication of the second resource.

In some examples, the indication of the second resource includes the first Doppler shift.

In some examples, the uplink resource indication receiver 825 may be configured as or otherwise support a means for receiving, from the node and before measuring the first reference signal, an indication of a set of resources including the first resource and the second resource, where the second resource is based on receiving the indication of the set of resources.

In some examples, a duration between the first resource and the second resource is based on the first Doppler shift.

In some examples, the Doppler shift range indication receiver 855 may be configured as or otherwise support a means for receiving, from the node, an indication of a set of Doppler shift ranges, where the duration between the first resource and the second resource is based on a Doppler shift range of the set of Doppler shift ranges that includes the first Doppler shift.

In some examples, the uplink resource indication receiver 825 may be configured as or otherwise support a means for receiving, from the node, an indication of the second resource for transmitting the second channel feedback report.

In some examples, the uplink resource indication transmitter 845 may be configured as or otherwise support a means for transmitting, to the node, a second indication of the second resource, where receiving the indication of the second resource is based on transmitting the second indication of the second resource.

In some examples, the uplink resource indication receiver 825 may be configured as or otherwise support a means for receiving, from the node and before measuring the first reference signal, an indication of a first set of resources associated with a first resource pattern, the first set of resources including the first resource. In some examples, the uplink resource indication receiver 825 may be configured as or otherwise support a means for receiving, from the node, an indication of a second set of resources associated with a second resource pattern, the second set of resources including the second resource, where the second resource is based on receiving the indication of the second set of resources.

In some examples, the indication of the second resource is received via a medium access control (MAC) control element (MAC-CE) or DCI.

In some examples, the uplink resource indication receiver 825 may be configured as or otherwise support a means for receiving an indication of an updated transmission configuration indicator state, a configuration for an uplink transmit power control command, or both, associated with a distance or a periodicity of the second resource relative to the first resource.

In some examples, the node includes a transmission reception point.

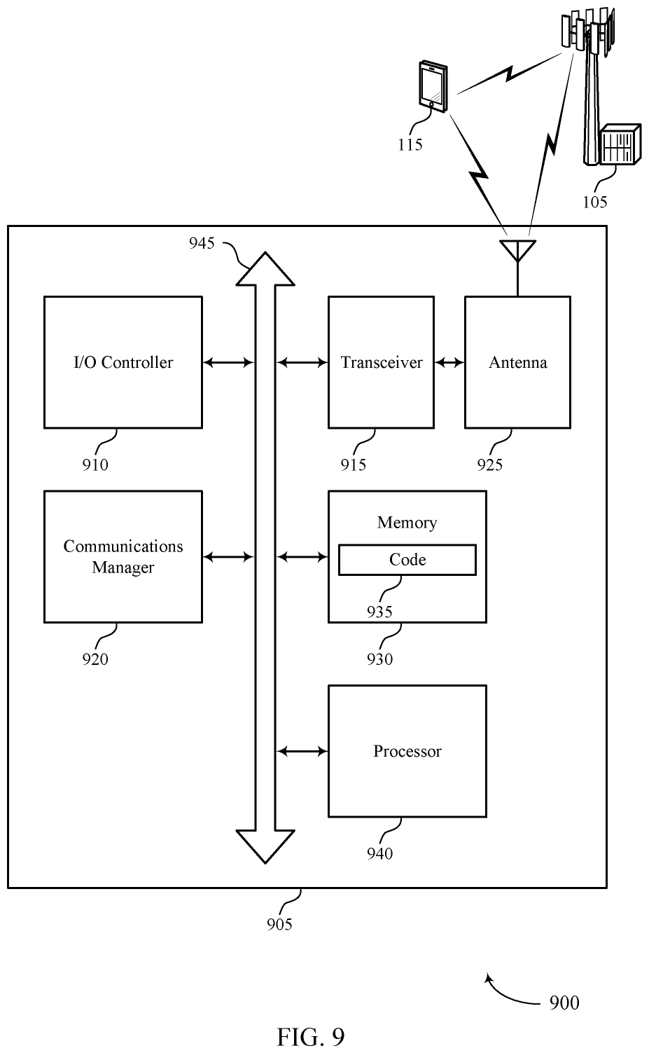

FIG. 9 shows a diagram of a system 900 including a device 905 that supports adaptive Doppler feedback in accordance with one or more aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting adaptive Doppler feedback). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving an indication of one or more uplink resources for channel feedback reporting by the UE. The communications manager 920 may be configured as or otherwise support a means for receiving, from one or more nodes, one or more reference signals. The communications manager 920 may be configured as or otherwise support a means for transmitting, via at least one uplink resource of the one or more uplink resources, a channel feedback report including measurement information, where the at least one uplink resource is based on a mobility parameter associated with the UE.

Additionally or alternatively, the communications manager 920 may support wireless communication at a UE in accordance with examples as disclosed herein. For example, the communications manager 920 may be configured as or otherwise support a means for measuring a first reference signal received from a node. The communications manager 920 may be configured as or otherwise support a means for transmitting, to the node, a first channel feedback report using a first resource, the first channel feedback report including a first Doppler shift associated with measuring the first reference signal. The communications manager 920 may be configured as or otherwise support a means for measuring a second reference signal received from the node. The communications manager 920 may be configured as or otherwise support a means for transmitting, to the node, a second channel feedback report using a second resource, the second resource based on measuring the first reference signal, the second channel feedback report including a second Doppler shift associated with measuring the second reference signal.

By including or configuring the communications manager 920 in accordance with examples as described herein, the device 905 may support techniques for the device 905 to reduce power consumption by reducing a number of uplink resources over which the device 905 conveys channel feedback.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of adaptive Doppler feedback as described herein, or the processor 940 and the memory 930 may be otherwise configured to perform or support such operations.

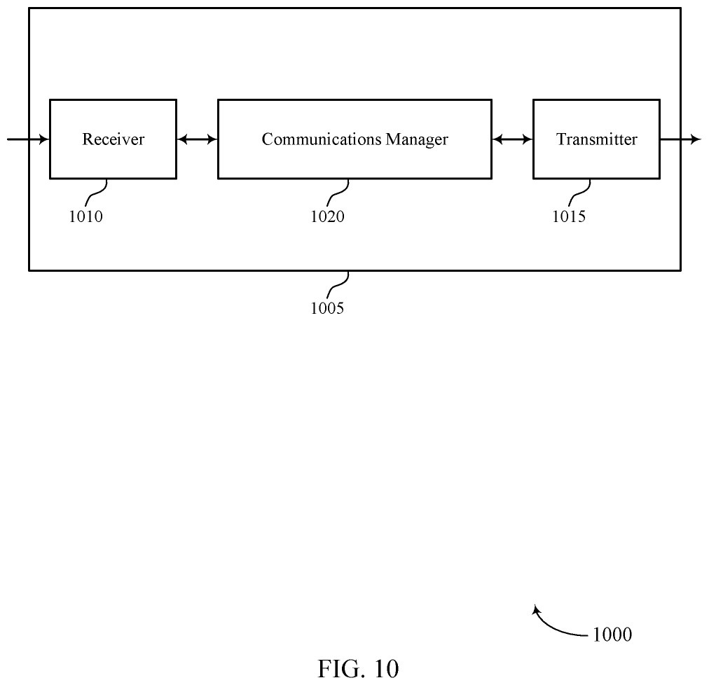

FIG. 10 shows a block diagram 1000 of a device 1005 that supports adaptive Doppler feedback in accordance with one or more aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to adaptive Doppler feedback). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to adaptive Doppler feedback). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of adaptive Doppler feedback as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a node in accordance with examples as disclosed herein. For example, the communications manager 1020 may be configured as or otherwise support a means for transmitting, to a UE, an indication of one or more uplink resources for channel feedback reporting by the UE. The communications manager 1020 may be configured as or otherwise support a means for transmitting, to the UE, one or more reference signals. The communications manager 1020 may be configured as or otherwise support a means for receiving, via at least one uplink resource of the one or more uplink resources, a channel feedback report including measurement information, where the at least one uplink resource is based on a mobility parameter associated with the UE.

Additionally or alternatively, the communications manager 1020 may support wireless communication at a node in accordance with examples as disclosed herein. For example, the communications manager 1020 may be configured as or otherwise support a means for transmitting, to a UE, a first reference signal. The communications manager 1020 may be configured as or otherwise support a means for receiving, from the UE, a first channel feedback report using a first resource, the first channel feedback report including a first Doppler shift based on the first reference signal. The communications manager 1020 may be configured as or otherwise support a means for transmitting, to the UE, a second reference signal. The communications manager 1020 may be configured as or otherwise support a means for receiving, from the UE, a second channel feedback report using a second resource, the second channel feedback report including a second Doppler shift based on the second reference signal, the second resource based on the first reference signal.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for the device 1005 to reduce power consumption at a UE by reducing a number of uplink resources over which the UE conveys channel feedback to the device 1005.

The communications manager 1020 may be an example of means for performing various aspects of adaptive Doppler feedback as described herein. The communications manager 1020, or its sub-components, may be implemented in hardware (e.g., in communications management circuitry). The circuitry may comprise of processor, digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

In another implementation, the communications manager 1020, or its sub-components, may be implemented in code (e.g., as communications management software or firmware) executed by a processor, or any combination thereof. If implemented in code executed by a processor, the functions of the communications manager 1020, or its sub-components may be executed by a general-purpose processor, a digital signal processor (DSP), an application-specific integrated circuit (ASIC), a field programmable gate array (FPGA) or other programmable logic device.

In some examples, the communications manager 1020 may be configured to perform various operations (e.g., receiving, determining, transmitting) using or otherwise in cooperation with the receiver 1010, the transmitter 1015, or both

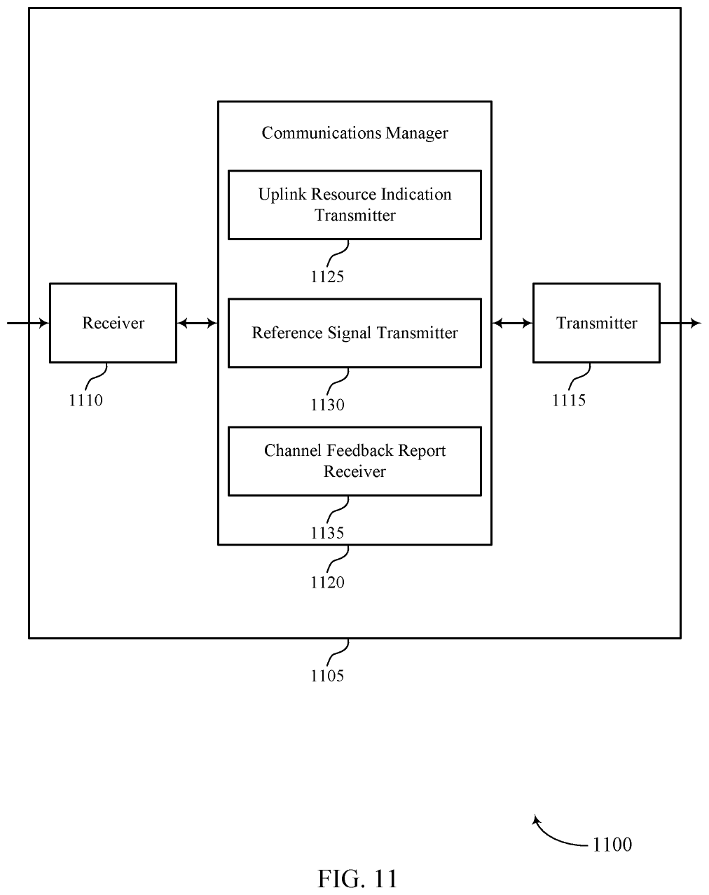

FIG. 11 shows a block diagram 1100 of a device 1105 that supports adaptive Doppler feedback in accordance with one or more aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to adaptive Doppler feedback). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to adaptive Doppler feedback). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of adaptive Doppler feedback as described herein. For example, the communications manager 1120 may include an uplink resource indication transmitter 1125, a reference signal transmitter 1130, a channel feedback report receiver 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a node in accordance with examples as disclosed herein. The uplink resource indication transmitter 1125 may be configured as or otherwise support a means for transmitting, to a UE, an indication of one or more uplink resources for channel feedback reporting by the UE. The reference signal transmitter 1130 may be configured as or otherwise support a means for transmitting, to the UE, one or more reference signals. The channel feedback report receiver 1135 may be configured as or otherwise support a means for receiving, via at least one uplink resource of the one or more uplink resources, a channel feedback report including measurement information, where the at least one uplink resource is based on a mobility parameter associated with the UE.

Additionally or alternatively, the communications manager 1120 may support wireless communication at a node in accordance with examples as disclosed herein. The reference signal transmitter 1130 may be configured as or otherwise support a means for transmitting, to a UE, a first reference signal. The channel feedback report receiver 1135 may be configured as or otherwise support a means for receiving, from the UE, a first channel feedback report using a first resource, the first channel feedback report including a first Doppler shift based on the first reference signal. The reference signal transmitter 1130 may be configured as or otherwise support a means for transmitting, to the UE, a second reference signal. The channel feedback report receiver 1135 may be configured as or otherwise support a means for receiving, from the UE, a second channel feedback report using a second resource, the second channel feedback report including a second Doppler shift based on the second reference signal, the second resource based on the first reference signal.

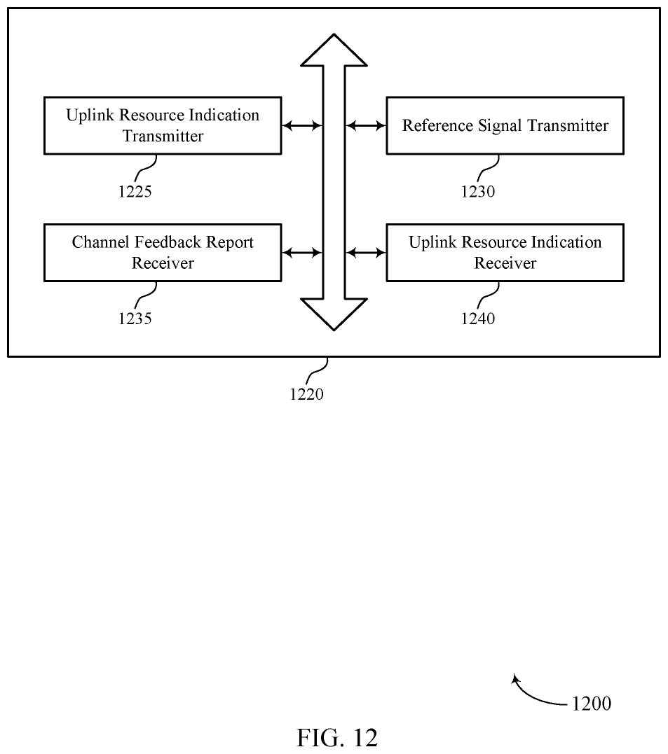

FIG. 12 shows a block diagram 1200 of a communications manager 1220 that supports adaptive Doppler feedback in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of adaptive Doppler feedback as described herein. For example, the communications manager 1220 may include an uplink resource indication transmitter 1225, a reference signal transmitter 1230, a channel feedback report receiver 1235, an uplink resource indication receiver 1240, or any combination thereof. Each of these components may communicate, directly or indirectly, with one another (e.g., via one or more buses).

The communications manager 1220 may support wireless communication at a node in accordance with examples as disclosed herein. The uplink resource indication transmitter 1225 may be configured as or otherwise support a means for transmitting, to a UE, an indication of one or more uplink resources for channel feedback reporting by the UE. The reference signal transmitter 1230 may be configured as or otherwise support a means for transmitting, to the UE, one or more reference signals. The channel feedback report receiver 1235 may be configured as or otherwise support a means for receiving, via at least one uplink resource of the one or more uplink resources, a channel feedback report including measurement information, where the at least one uplink resource is based on a mobility parameter associated with the UE.

In some examples, the one or more uplink resources includes two or more uplink resources, and the channel feedback report receiver 1235 may be configured as or otherwise support a means for receiving, for each of a subset of the two or more uplink resources, a first channel feedback report including a first indication of a first Doppler shift associated with measurement of a first one or more reference signals by the UE.

In some examples, the one or more uplink resources includes three or more uplink resources. In some examples, a first time duration between a first uplink resource of the three or more uplink resources and a second uplink resource of the three or more uplink resources that is adjacent to the first uplink resource is different than a second time duration between the second uplink resource and a third uplink resource of the three or more uplink resources that is adjacent to the second uplink resource.

Additionally or alternatively, the communications manager 1220 may support wireless communication at a node in accordance with examples as disclosed herein. In some examples, the reference signal transmitter 1230 may be configured as or otherwise support a means for transmitting, to a UE, a first reference signal. In some examples, the channel feedback report receiver 1235 may be configured as or otherwise support a means for receiving, from the UE, a first channel feedback report using a first resource, the first channel feedback report including a first Doppler shift based on the first reference signal. In some examples, the reference signal transmitter 1230 may be configured as or otherwise support a means for transmitting, to the UE, a second reference signal. In some examples, the channel feedback report receiver 1235 may be configured as or otherwise support a means for receiving, from the UE, a second channel feedback report using a second resource, the second channel feedback report including a second Doppler shift based on the second reference signal, the second resource based on the first reference signal.

In some examples, the uplink resource indication receiver 1240 may be configured as or otherwise support a means for receiving, from the UE, an indication of the second resource, where receiving the second channel feedback report using the second resource is based on receiving the indication of the second resource.

In some examples, the uplink resource indication transmitter 1225 may be configured as or otherwise support a means for transmitting, to the UE, an indication of the second resource based on receiving the first channel feedback report using the first resource, where receiving the second channel feedback report using the second resource is based on transmitting the indication of the second resource.

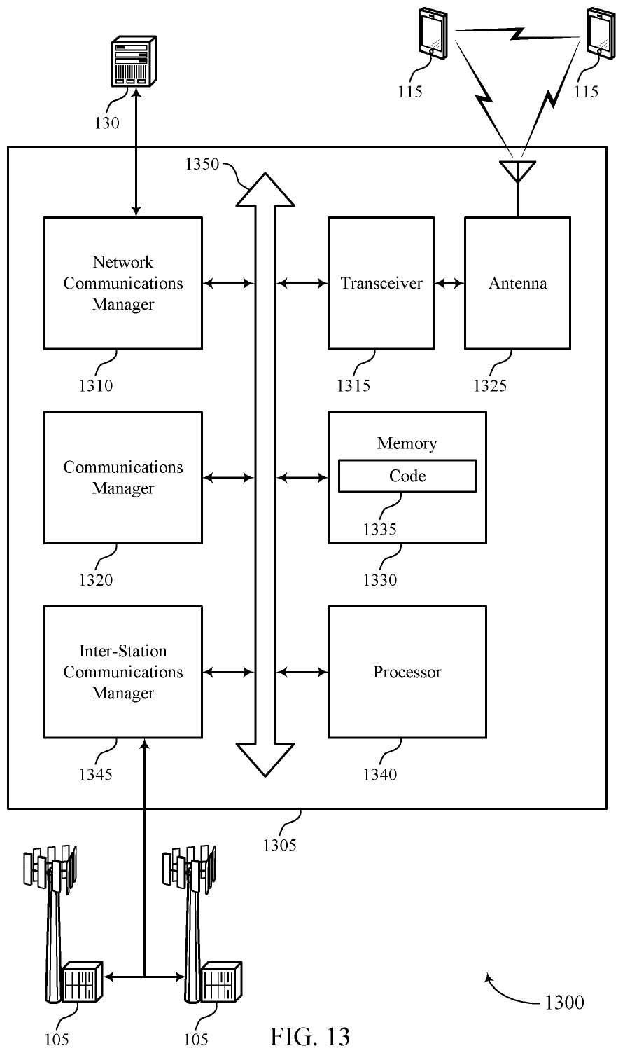

FIG. 13 shows a diagram of a system 1300 including a device 1305 that supports adaptive Doppler feedback in accordance with one or more aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting adaptive Doppler feedback). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a node in accordance with examples as disclosed herein. For example, the communications manager 1320 may be configured as or otherwise support a means for transmitting, to a UE, an indication of one or more uplink resources for channel feedback reporting by the UE. The communications manager 1320 may be configured as or otherwise support a means for transmitting, to the UE, one or more reference signals. The communications manager 1320 may be configured as or otherwise support a means for receiving, via at least one uplink resource of the one or more uplink resources, a channel feedback report including measurement information, where the at least one uplink resource is based on a mobility parameter associated with the UE.

Additionally or alternatively, the communications manager 1320 may support wireless communication at a node in accordance with examples as disclosed herein. For example, the communications manager 1320 may be configured as or otherwise support a means for transmitting, to a UE, a first reference signal. The communications manager 1320 may be configured as or otherwise support a means for receiving, from the UE, a first channel feedback report using a first resource, the first channel feedback report including a first Doppler shift based on the first reference signal. The communications manager 1320 may be configured as or otherwise support a means for transmitting, to the UE, a second reference signal. The communications manager 1320 may be configured as or otherwise support a means for receiving, from the UE, a second channel feedback report using a second resource, the second channel feedback report including a second Doppler shift based on the second reference signal, the second resource based on the first reference signal.

By including or configuring the communications manager 1320 in accordance with examples as described herein, the device 1305 may support techniques for the device 1305 to reduce power consumption at a UE by reducing a number of uplink resources over which the UE conveys channel feedback to the device 1305

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of adaptive Doppler feedback as described herein, or the processor 1340 and the memory 1330 may be otherwise configured to perform or support such operations.

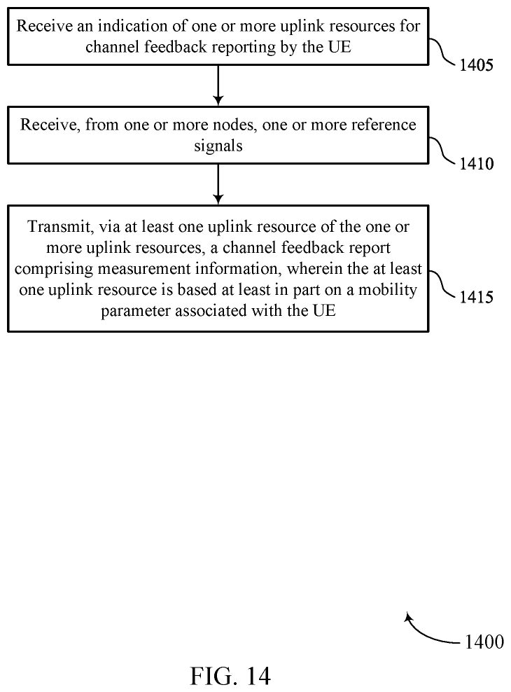

FIG. 14 shows a flowchart illustrating a method 1400 that supports adaptive Doppler feedback in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving an indication of one or more uplink resources for channel feedback reporting by the UE. The operations of 1405 may be performed in accordance with examples as disclosed herein. In some examples, aspects of the operations of 1405 may be performed by an uplink resource indication receiver 825 as described with reference to FIG. 8.

At 1410, the method may include receiving, from one or more nodes, one or more reference signals. The operations of 1410 may be performed in accordance with examples as disclosed herein. In some examples, aspects of the operations of 1410 may be performed by a reference signal receiver 830 as described with reference to FIG. 8.

At 1415, the method may include transmitting, via at least one uplink resource of the one or more uplink resources, a channel feedback report including measurement information, where the at least one uplink resource is based on a mobility parameter associated with the UE. The operations of 1415 may be performed in accordance with examples as disclosed herein. In some examples, aspects of the operations of 1415 may be performed by a channel feedback report transmitter 835 as described with reference to FIG. 8.

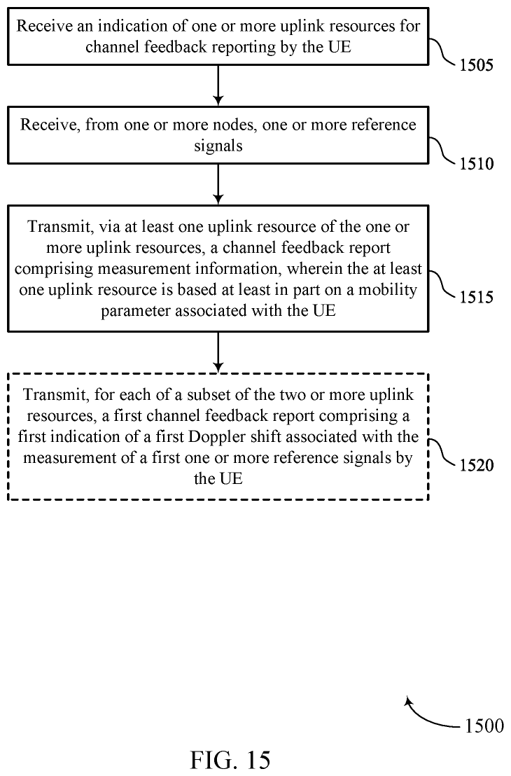

FIG. 15 shows a flowchart illustrating a method 1500 that supports adaptive Doppler feedback in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving an indication of one or more uplink resources for channel feedback reporting by the UE. The operations of 1505 may be performed in accordance with examples as disclosed herein. In some examples, aspects of the operations of 1505 may be performed by an uplink resource indication receiver 825 as described with reference to FIG. 8.

At 1510, the method may include receiving, from one or more nodes, one or more reference signals. The operations of 1510 may be performed in accordance with examples as disclosed herein. In some examples, aspects of the operations of 1510 may be performed by a reference signal receiver 830 as described with reference to FIG. 8.

At 1515, the method may include transmitting, via at least one uplink resource of the one or more uplink resources, a channel feedback report including measurement information, where the at least one uplink resource is based on a mobility parameter associated with the UE. The operations of 1515 may be performed in accordance with examples as disclosed herein. In some examples, aspects of the operations of 1515 may be performed by a channel feedback report transmitter 835 as described with reference to FIG. 8.

At 1520, the method may include transmitting, for each of a subset of the two or more uplink resources, a first channel feedback report including a first indication of a first Doppler shift associated with measurement of a first one or more reference signals by the UE. The operations of 1520 may be performed in accordance with examples as disclosed herein. In some examples, aspects of the operations of 1520 may be performed by a channel feedback report transmitter 835 as described with reference to FIG. 8.

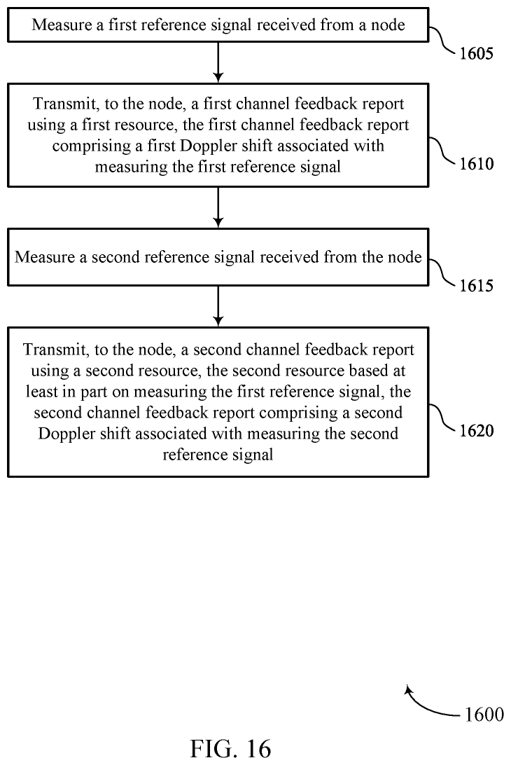

FIG. 16 shows a flowchart illustrating a method 1600 that supports adaptive Doppler feedback in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include measuring a first reference signal received from a node. The operations of 1605 may be performed in accordance with examples as disclosed herein. In some examples, aspects of the operations of 1605 may be performed by a reference signal receiver 830 as described with reference to FIG. 8.

At 1610, the method may include transmitting, to the node, a first channel feedback report using a first resource, the first channel feedback report including a first Doppler shift associated with measuring the first reference signal. The operations of 1610 may be performed in accordance with examples as disclosed herein. In some examples, aspects of the operations of 1610 may be performed by a channel feedback report transmitter 835 as described with reference to FIG. 8.

At 1615, the method may include measuring a second reference signal received from the node. The operations of 1615 may be performed in accordance with examples as disclosed herein. In some examples, aspects of the operations of 1615 may be performed by a reference signal receiver 830 as described with reference to FIG. 8.

At 1620, the method may include transmitting, to the node, a second channel feedback report using a second resource, the second resource based on measuring the first reference signal, the second channel feedback report including a second Doppler shift associated with measuring the second reference signal. The operations of 1620 may be performed in accordance with examples as disclosed herein. In some examples, aspects of the operations of 1620 may be performed by a channel feedback report transmitter 835 as described with reference to FIG. 8.

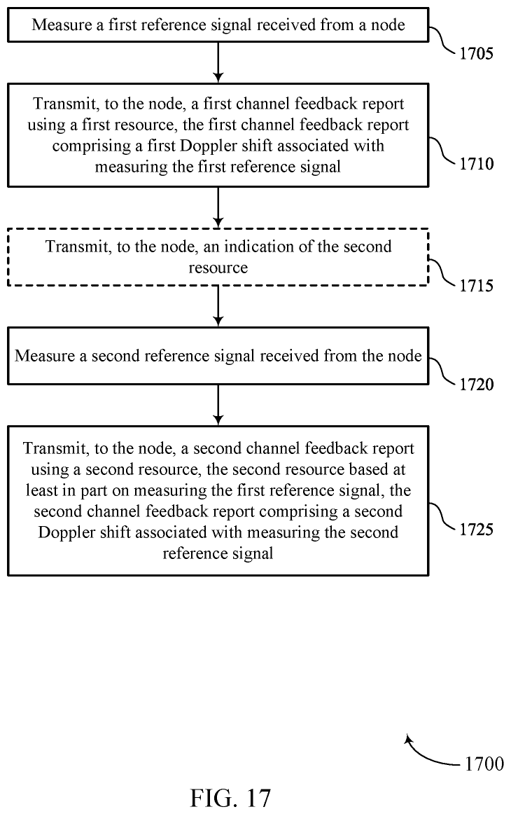

FIG. 17 shows a flowchart illustrating a method 1700 that supports adaptive Doppler feedback in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include measuring a first reference signal received from a node. The operations of 1705 may be performed in accordance with examples as disclosed herein. In some examples, aspects of the operations of 1705 may be performed by a reference signal receiver 830 as described with reference to FIG. 8.

At 1710, the method may include transmitting, to the node, a first channel feedback report using a first resource, the first channel feedback report including a first Doppler shift associated with measuring the first reference signal. The operations of 1710 may be performed in accordance with examples as disclosed herein. In some examples, aspects of the operations of 1710 may be performed by a channel feedback report transmitter 835 as described with reference to FIG. 8.

At 1715, the method may include transmitting, to the node, an indication of the second resource. The operations of 1715 may be performed in accordance with examples as disclosed herein. In some examples, aspects of the operations of 1715 may be performed by an uplink resource indication transmitter 845 as described with reference to FIG. 8.

At 1720, the method may include measuring a second reference signal received from the node. The operations of 1720 may be performed in accordance with examples as disclosed herein. In some examples, aspects of the operations of 1720 may be performed by a reference signal receiver 830 as described with reference to FIG. 8.

At 1725, the method may include transmitting, to the node, a second channel feedback report using a second resource, the second resource based on measuring the first reference signal, the second channel feedback report including a second Doppler shift associated with measuring the second reference signal. The operations of 1725 may be performed in accordance with examples as disclosed herein. In some examples, aspects of the operations of 1725 may be performed by a channel feedback report transmitter 835 as described with reference to FIG. 8.

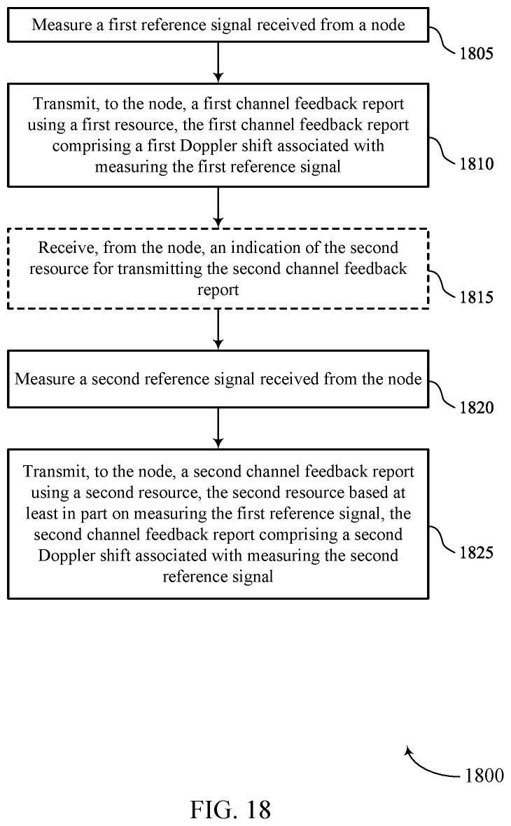

FIG. 18 shows a flowchart illustrating a method 1800 that supports adaptive Doppler feedback in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1805, the method may include measuring a first reference signal received from a node. The operations of 1805 may be performed in accordance with examples as disclosed herein. In some examples, aspects of the operations of 1805 may be performed by a reference signal receiver 830 as described with reference to FIG. 8.

At 1810, the method may include transmitting, to the node, a first channel feedback report using a first resource, the first channel feedback report including a first Doppler shift associated with measuring the first reference signal. The operations of 1810 may be performed in accordance with examples as disclosed herein. In some examples, aspects of the operations of 1810 may be performed by a channel feedback report transmitter 835 as described with reference to FIG. 8.

At 1815, the method may include receiving, from the node, an indication of the second resource for transmitting the second channel feedback report. The operations of 1815 may be performed in accordance with examples as disclosed herein. In some examples, aspects of the operations of 1815 may be performed by an uplink resource indication receiver 825 as described with reference to FIG. 8.

At 1820, the method may include measuring a second reference signal received from the node. The operations of 1820 may be performed in accordance with examples as disclosed herein. In some examples, aspects of the operations of 1820 may be performed by a reference signal receiver 830 as described with reference to FIG. 8.

At 1825, the method may include transmitting, to the node, a second channel feedback report using a second resource, the second resource based on measuring the first reference signal, the second channel feedback report including a second Doppler shift associated with measuring the second reference signal. The operations of 1825 may be performed in accordance with examples as disclosed herein. In some examples, aspects of the operations of 1825 may be performed by a channel feedback report transmitter 835 as described with reference to FIG. 8.

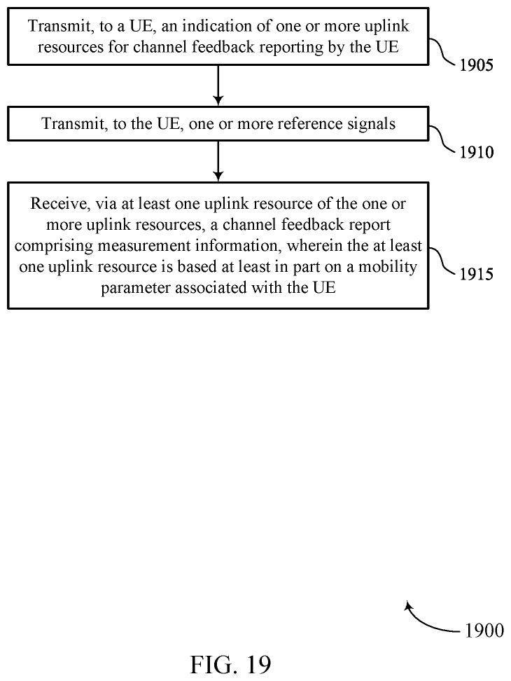

FIG. 19 shows a flowchart illustrating a method 1900 that supports adaptive Doppler feedback in accordance with one or more aspects of the present disclosure. The operations of the method 1900 may be implemented by a base station or its components as described herein. For example, the operations of the method 1900 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1905, the method may include transmitting, to a UE, an indication of one or more uplink resources for channel feedback reporting by the UE. The operations of 1905 may be performed in accordance with examples as disclosed herein. In some examples, aspects of the operations of 1905 may be performed by an uplink resource indication transmitter 1225 as described with reference to FIG. 12.

At 1910, the method may include transmitting, to the UE, one or more reference signals. The operations of 1910 may be performed in accordance with examples as disclosed herein. In some examples, aspects of the operations of 1910 may be performed by a reference signal transmitter 1230 as described with reference to FIG. 12.

At 1915, the method may include receiving, via at least one uplink resource of the one or more uplink resources, a channel feedback report including measurement information, where the at least one uplink resource is based on a mobility parameter associated with the UE. The operations of 1915 may be performed in accordance with examples as disclosed herein. In some examples, aspects of the operations of 1915 may be performed by a channel feedback report receiver 1235 as described with reference to FIG. 12.

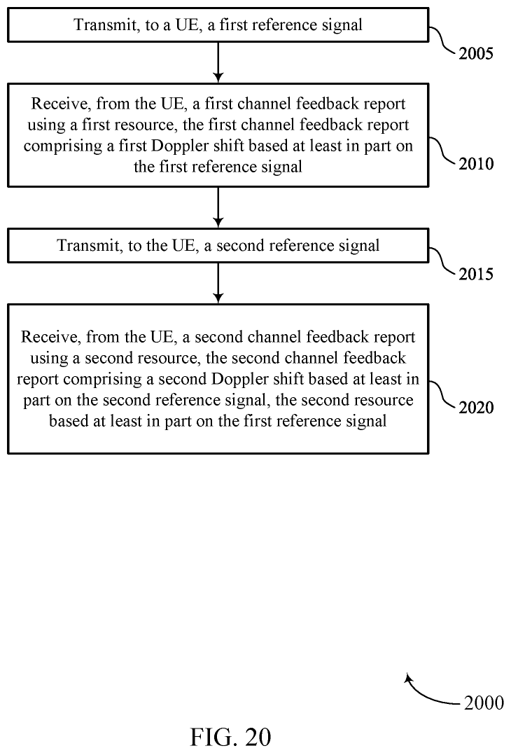

FIG. 20 shows a flowchart illustrating a method 2000 that supports adaptive Doppler feedback in accordance with one or more aspects of the present disclosure. The operations of the method 2000 may be implemented by a base station or its components as described herein. For example, the operations of the method 2000 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2005, the method may include transmitting, to a UE, a first reference signal. The operations of 2005 may be performed in accordance with examples as disclosed herein. In some examples, aspects of the operations of 2005 may be performed by a reference signal transmitter 1230 as described with reference to FIG. 12.

At 2010, the method may include receiving, from the UE, a first channel feedback report using a first resource, the first channel feedback report including a first Doppler shift based on the first reference signal. The operations of 2010 may be performed in accordance with examples as disclosed herein. In some examples, aspects of the operations of 2010 may be performed by a channel feedback report receiver 1235 as described with reference to FIG. 12.

At 2015, the method may include transmitting, to the UE, a second reference signal. The operations of 2015 may be performed in accordance with examples as disclosed herein. In some examples, aspects of the operations of 2015 may be performed by a reference signal transmitter 1230 as described with reference to FIG. 12.

At 2020, the method may include receiving, from the UE, a second channel feedback report using a second resource, the second channel feedback report including a second Doppler shift based on the second reference signal, the second resource based on the first reference signal. The operations of 2020 may be performed in accordance with examples as disclosed herein. In some examples, aspects of the operations of 2020 may be performed by a channel feedback report receiver 1235 as described with reference to FIG. 12.

The following provides an overview of aspects of the present disclosure:

Aspect 1: A method for wireless communication at a UE, comprising: receiving an indication of one or more uplink resources for channel feedback reporting by the UE; receiving, from one or more nodes, one or more reference signals; and transmitting, via at least one uplink resource of the one or more uplink resources, a channel feedback report comprising measurement information, wherein the at least one uplink resource is based at least in part on a mobility parameter associated with the UE.

Aspect 2: The method of aspect 1, wherein the one or more uplink resources comprises two or more uplink resources, the method further comprising: transmitting, for each of a subset of the two or more uplink resources, a first channel feedback report comprising a first indication of a first Doppler shift associated with measurement of a first one or more reference signals by the UE.

Aspect 3: The method of aspect 2, further comprising: selecting the subset of the two or more uplink resources based at least in part on a delta associated with one or more Doppler shift values based at least in part on measurement of the one or more reference signals by the UE.

Aspect 4: The method of aspect 3, wherein the subset of the two or more uplink resources excludes a first uplink resource of the two or more uplink resources based at least in part on the delta being below a threshold delta, the first uplink resource is different than the at least one uplink resource.

Aspect 5: The method of any of aspects 3 through 4, further comprising: receiving, from at least one of the one or more nodes, an indication to select the subset of the two or more uplink resources, wherein selecting the subset of the two or more uplink resources is based at least in part on receiving the indication to select the subset of the two or more uplink resources.

Aspect 6: The method of aspect 5, further comprising: receiving, from at least one of the one or more nodes, an indication of one or more conditions for selecting the subset of the two or more uplink resources, wherein selecting the subset of the two or more uplink resources is based at least in part on receiving the indication of the one or more conditions.

Aspect 7: The method of any of aspects 1 through 6, further comprising: receiving an indication of a resource configuration for the one or more uplink resources via semi-static control signaling.

Aspect 8: The method of any of aspects 1 through 7, wherein the one or more uplink resources comprises three or more uplink resources; and a first time duration between a first uplink resource of the three or more uplink resources and a second uplink resource of the three or more uplink resources that is adjacent to the first uplink resource is different than a second time duration between the second uplink resource and a third uplink resource of the three or more uplink resources that is adjacent to the second uplink resource.

Aspect 9: The method of aspect 8, wherein the first time duration is different than the second time duration based at least in part on the mobility parameter associated with the UE being different in the first time duration relative to the second time duration.

Aspect 10: The method of any of aspects 8 through 9, wherein the indication of the three or more uplink resources comprises an irregular time domain pattern for the three or more uplink resources, the irregular time domain pattern associated with a vector indicative of different timings between consecutive sets of uplink resources of the three or more uplink resources.

Aspect 11: The method of any of aspects 1 through 10, wherein the mobility parameter comprises a position of the UE, a displacement of the UE, a speed of the UE, a velocity of the UE, an acceleration of the UE, a Doppler shift associated with measurement of the one or more reference signals, or any combination thereof relative to the one or more nodes.

Aspect 12: The method of any of aspects 1 through 11, wherein the one or more uplink resources comprises two or more uplink resources; and a first uplink resource of the two or more uplink resources has a different report cycle than a second uplink resource of the two or more uplink resources, the first uplink resource has a different transmission configuration indicator state than the second uplink resource, or both, based at least in part on the first uplink resource being associated with a first geographic region corresponding to a first Doppler variation and the second uplink resource being associated with a second geographic region corresponding to a second Doppler variation.

Aspect 13: The method of any of aspects 1 through 12, wherein the one or more nodes comprises one or more transmission reception points.

Aspect 14: A method for wireless communication at a UE, comprising: measuring a first reference signal received from a node; transmitting, to the node, a first channel feedback report using a first resource, the first channel feedback report comprising a first Doppler shift associated with measuring the first reference signal; measuring a second reference signal received from the node; and transmitting, to the node, a second channel feedback report using a second resource, the second resource based at least in part on measuring the first reference signal, the second channel feedback report comprising a second Doppler shift associated with measuring the second reference signal.

Aspect 15: The method of aspect 14, further comprising: transmitting, to the node, an indication of the second resource.

Aspect 16: The method of aspect 15, wherein the indication of the second resource comprises the first Doppler shift.

Aspect 17: The method of any of aspects 15 through 16, further comprising: receiving, from the node and before measuring the first reference signal, an indication of a set of resources comprising the first resource and the second resource, wherein the second resource is based at least in part on receiving the indication of the set of resources.

Aspect 18: The method of any of aspects 14 through 17, wherein a duration between the first resource and the second resource is based at least in part on the first Doppler shift.

Aspect 19: The method of aspect 18, further comprising: receiving, from the node, an indication of a set of Doppler shift ranges, wherein the duration between the first resource and the second resource is based at least in part on a Doppler shift range of the set of Doppler shift ranges that includes the first Doppler shift.

Aspect 20: The method of any of aspects 14 through 19, further comprising: receiving, from the node, an indication of the second resource for transmitting the second channel feedback report.

Aspect 21: The method of aspect 20, further comprising: transmitting, to the node, a second indication of the second resource, wherein receiving the indication of the second resource is based at least in part on transmitting the second indication of the second resource.

Aspect 22: The method of any of aspects 20 through 21, further comprising: receiving, from the node and before measuring the first reference signal, an indication of a first set of resources associated with a first resource pattern, the first set of resources comprising the first resource; and receiving, from the node, an indication of a second set of resources associated with a second resource pattern, the second set of resources comprising the second resource, wherein the second resource is based at least in part on receiving the indication of the second set of resources.

Aspect 23: The method of any of aspects 20 through 22, wherein the indication of the second resource is received via a medium access control (MAC) control element (MAC-CE) or DCI.

Aspect 24: The method of any of aspects 20 through 23, the receiving the indication of the second resource comprising: receiving an indication of an updated transmission configuration indicator state, a configuration for an uplink transmit power control command, or both, associated with a distance or a periodicity of the second resource relative to the first resource.

Aspect 25: The method of any of aspects 14 through 24, wherein the node comprises a transmission reception point.

Aspect 26: A method for wireless communication at a node, comprising: transmitting, to a UE, an indication of one or more uplink resources for channel feedback reporting by the UE; transmitting, to the UE, one or more reference signals; and receiving, via at least one uplink resource of the one or more uplink resources, a channel feedback report comprising measurement information, wherein the at least one uplink resource is based at least in part on a mobility parameter associated with the UE.

Aspect 27: The method of aspect 26, wherein the one or more uplink resources comprises two or more uplink resources, the method further comprising: receiving, for each of a subset of the two or more uplink resources, a first channel feedback report comprising a first indication of a first Doppler shift associated with measurement of a first one or more reference signals by the UE.

Aspect 28: The method of any of aspects 26 through 27, wherein the one or more uplink resources comprises three or more uplink resources; and a first time duration between a first uplink resource of the three or more uplink resources and a second uplink resource of the three or more uplink resources that is adjacent to the first uplink resource is different than a second time duration between the second uplink resource and a third uplink resource of the three or more uplink resources that is adjacent to the second uplink resource.

Aspect 29: A method for wireless communication at a node, comprising: transmitting, to a UE, a first reference signal; receiving, from the UE, a first channel feedback report using a first resource, the first channel feedback report comprising a first Doppler shift based at least in part on the first reference signal; transmitting, to the UE, a second reference signal; and receiving, from the UE, a second channel feedback report using a second resource, the second channel feedback report comprising a second Doppler shift based at least in part on the second reference signal, the second resource based at least in part on the first reference signal.

Aspect 30: The method of aspect 29, further comprising: receiving, from the UE, an indication of the second resource, wherein receiving the second channel feedback report using the second resource is based at least in part on receiving the indication of the second resource.

Aspect 31: An apparatus for wireless communication at a UE, comprising a processor and memory coupled with the processor, wherein the processor and memory are configured to perform a method of any of aspects 1 through 13.

Aspect 32: An apparatus for wireless communication at a UE, comprising at least one means for performing a method of any of aspects 1 through 13.

Aspect 33: A non-transitory computer-readable medium storing code for wireless communication at a UE, the code comprising instructions executable by a processor to perform a method of any of aspects 1 through 13.

Aspect 34: An apparatus for wireless communication at a UE, comprising a processor and memory coupled with the processor, wherein the processor and memory are configured to perform a method of any of aspects 14 through 25.

Aspect 35: An apparatus for wireless communication at a UE, comprising at least one means for performing a method of any of aspects 14 through 25.

Aspect 36: A non-transitory computer-readable medium storing code for wireless communication at a UE, the code comprising instructions executable by a processor to perform a method of any of aspects 14 through 25.

Aspect 37: An apparatus for wireless communication at a node, comprising a processor and memory coupled with the processor, wherein the processor and memory are configured to perform a method of any of aspects 26 through 28.

Aspect 38: An apparatus for wireless communication at a node, comprising at least one means for performing a method of any of aspects 26 through 28.

Aspect 39: A non-transitory computer-readable medium storing code for wireless communication at a node, the code comprising instructions executable by a processor to perform a method of any of aspects 26 through 28.

Aspect 40: An apparatus for wireless communication at a node, comprising a processor and memory coupled with the processor, wherein the processor and memory are configured to perform a method of any of aspects 29 through 30.

Aspect 41: An apparatus for wireless communication at a node, comprising at least one means for performing a method of any of aspects 29 through 30.

Aspect 42: A non-transitory computer-readable medium storing code for wireless communication at a node, the code comprising instructions executable by a processor to perform a method of any of aspects 29 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor and memory configured to:
receive an indication of one or more uplink resources for channel feedback reporting by the UE;
receive, from one or more nodes, one or more reference signals; and
transmit, via at least one uplink resource of the one or more uplink resources, a channel feedback report comprising measurement information, wherein the at least one uplink resource is based at least in part on a mobility parameter associated with the UE.

2. The apparatus of claim 1, wherein the one or more uplink resources comprises two or more uplink resources, and wherein the processor and memory are further configured to:
transmit, for each of a subset of the two or more uplink resources, a first channel feedback report comprising a first indication of a first Doppler shift associated with measurement of a first one or more reference signals by the UE.

3. The apparatus of claim 2, wherein the processor and memory are further configured to:
select the subset of the two or more uplink resources based at least in part on a delta associated with one or more Doppler shift values based at least in part on measurement of the one or more reference signals by the UE.

4. The apparatus of claim 3, wherein the subset of the two or more uplink resources excludes a first uplink resource of the two or more uplink resources based at least in part on the delta being below a threshold delta, wherein the first uplink resource is different than the at least one uplink resource.

5. The apparatus of claim 3, wherein the processor and memory are further configured to:
receive, from at least one of the one or more nodes, an indication to select the subset of the two or more uplink resources, wherein selecting the subset of the two or more uplink resources is based at least in part on receiving the indication to select the subset of the two or more uplink resources.

6. The apparatus of claim 5, wherein the processor and memory are further configured to:
receive, from at least one of the one or more nodes, an indication of one or more conditions for selecting the subset of the two or more uplink resources, wherein selecting the subset of the two or more uplink resources is based at least in part on receiving the indication of the one or more conditions.

7. The apparatus of claim 1, wherein the processor and memory are further configured to:
receive an indication of a resource configuration for the one or more uplink resources via semi-static control signaling.

8. The apparatus of claim 1, wherein:
the one or more uplink resources comprises three or more uplink resources; and
a first time duration between a first uplink resource of the three or more uplink resources and a second uplink resource of the three or more uplink resources that is adjacent to the first uplink resource is different than a second time duration between the second uplink resource and a third uplink resource of the three or more uplink resources that is adjacent to the second uplink resource.

9. The apparatus of claim 8, wherein the first time duration is different than the second time duration based at least in part on the mobility parameter associated with the UE being different in the first time duration relative to the second time duration.

10. The apparatus of claim 8, wherein the indication of the three or more uplink resources comprises an irregular time domain pattern for the three or more uplink resources, the irregular time domain pattern associated with a vector indicative of different timings between consecutive sets of uplink resources of the three or more uplink resources.

11. The apparatus of claim 1, wherein the mobility parameter comprises a position of the UE, a displacement of the UE, a speed of the UE, a velocity of the UE, an acceleration of the UE, a Doppler shift associated with measurement of the one or more reference signals, or any combination thereof relative to the one or more nodes.

12. The apparatus of claim 1, wherein:
the one or more uplink resources comprises two or more uplink resources; and
a first uplink resource of the two or more uplink resources has a different report cycle than a second uplink resource of the two or more uplink resources, the first uplink resource has a different transmission configuration indicator state than the second uplink resource, or both, based at least in part on the first uplink resource being associated with a first geographic region corresponding to a first Doppler variation and the second uplink resource being associated with a second geographic region corresponding to a second Doppler variation.

13. The apparatus of claim 1, wherein the one or more nodes comprises one or more transmission reception points.

14. apparatus for wireless communication at a user equipment (UE), comprising:
a processor; and
memory coupled with the processor, wherein the processor and memory are configured to:
measure a first reference signal received from a node;
transmit, to the node, a first channel feedback report using a first resource, the first channel feedback report comprising a first Doppler shift associated with measuring the first reference signal;
measure a second reference signal received from the node; and
transmit, to the node, a second channel feedback report using a second resource, the second resource based at least in part on measuring the first reference signal, the second channel feedback report comprising a second Doppler shift associated with measuring the second reference signal.

15. The apparatus of claim 14, wherein the processor and memory are further configured to:
transmit, to the node, an indication of the second resource .

16. The apparatus of claim 15, wherein the indication of the second resource comprises the first Doppler shift.

17. The apparatus of claim 15, wherein the processor and memory are further configured to:
receive, from the node and before measuring the first reference signal, an indication of a set of resources comprising the first resource and the second resource, wherein the second resource is based at least in part on receiving the indication of the set of resources.

18. The apparatus of claim 14, wherein a duration between the first resource and the second resource is based at least in part on the first Doppler shift.

19. The apparatus of claim 18, wherein the processor and memory are further configured to:
receive, from the node, an indication of a set of Doppler shift ranges, wherein the duration between the first resource and the second resource is based at least in part on a Doppler shift range of the set of Doppler shift ranges that includes the first Doppler shift.

20. The apparatus of claim 14, wherein the processor and memory are further configured to:
receive, from the node, an indication of the second resource for transmitting the second channel feedback report .

21. The apparatus of claim 20, further comprising:
transmitting, to the node, a second indication of the second resource, wherein receiving the indication of the second resource is based at least in part on transmitting the second indication of the second resource.

22. The apparatus of claim 20, wherein the processor and memory are further configured to:
receive, from the node and before measuring the first reference signal, an indication of a first set of resources associated with a first resource pattern, the first set of resources comprising the first resource; and
receive, from the node, an indication of a second set of resources associated with a second resource pattern, the second set of resources comprising the second resource, wherein the second resource is based at least in part on receiving the indication of the second set of resources.

23. The apparatus of claim 20, wherein the indication of the second resource is received via a medium access control (MAC) control element (MAC-CE) or downlink control information (DCI).

24. The apparatus of claim 20, wherein the processor and memory being configured to:
receive the indication of the second resource comprises the processor and the memory being configured to receive an indication of an updated transmission configuration indicator state, a configuration for an uplink transmit power control command, or both, associated with a distance or a periodicity of the second resource relative to the first resource.

25. The apparatus of claim 14, wherein the node comprises a transmission reception point.

26. An apparatus for wireless communication at a node, comprising:
a processor; and
memory coupled with the processor, wherein the processor and memory are configured to:
transmit, to a user equipment (UE), an indication of one or more uplink resources for channel feedback reporting by the UE;
transmit, to the UE, one or more reference signals; and
receive, via at least one uplink resource of the one or more uplink resources, a channel feedback report comprising measurement information, wherein the at least one uplink resource is based at least in part on a mobility parameter associated with the UE.

27. The apparatus of claim 26, wherein the one or more uplink resources comprises two or more uplink resources, and wherein the processor and memory are further configured to:
receive, for each of a subset of the two or more uplink resources, a first channel feedback report comprising a first indication of a first Doppler shift associated with measurement of a first one or more reference signals by the UE.

28. The apparatus of claim 26, wherein:
the one or more uplink resources comprises three or more uplink resources; and
a first time duration between a first uplink resource of the three or more uplink resources and a second uplink resource of the three or more uplink resources that is adjacent to the first uplink resource is different than a second time duration between the second uplink resource and a third uplink resource of the three or more uplink resources that is adjacent to the second uplink resource.

29. An apparatus for wireless communication at a node, comprising:
a processor; and
memory coupled with the processor, wherein the processor and memory are configured to:
transmit, to a user equipment (UE), a first reference signal;
receive, from the UE, a first channel feedback report using a first resource, the first channel feedback report comprising a first Doppler shift based at least in part on the first reference signal;
transmit, to the UE, a second reference signal; and
receive, from the UE, a second channel feedback report using a second resource, the second channel feedback report comprising a second Doppler shift based at least in part on the second reference signal, the second resource based at least in part on the first reference signal.

30. The apparatus of claim 29, wherein the processor and memory are further configured to:
receive, from the UE, an indication of the second resource, wherein receiving the second channel feedback report using the second resource is based at least in part on receiving the indication of the second resource.
